(19) United States
(12) Patent Application Publication
(10) Pub. No.: US 2012/0253891 A1
(43) Pub. Date: Oct. 4, 2012

(54) Computer-Implemented Generation Of Roadmap Visualizations

(75) Inventors: Jeremy Edward Hayes, Washington, DC (US); Gregg Howard Rosenberg, Reston, VA (US)

(73) Assignee: THE CORPORATE EXECUTIVE BOARD, Arlington, VA (US)

(21) Appl. No.: 13/435,942

(22) Filed: Mar. 30, 2012

Related U.S. Application Data
(60) Provisional application No. 61/470,522, filed on Apr. 1, 2011.

(51) Int. Cl. G06Q 10/06

(52) U.S. Cl. 705/7.39

(57) ABSTRACT

A method, computer program product, and system for generating a roadmap visualization for a set of topics, comprising collecting topic data about each topic in a set of topics from an entity, analyzing the collected topic data to calculate one or more business scores for each topic, generating a visualization by plotting entity datapoints for each topic in a visualization format, where visual characteristics of the entity datapoints indicate the business scores for each topic, and displaying the visualization on a display device. The topics may relate to information technology, human resources, risk, audit, capital planning, research and development, or any other entity-related topic desired to be visualized, and the business scores may be any suitable information desired to be visualized, such as risk scores, business impact scores, implementation scores, or alignment scores.

### CROSS-REFERENCE TO RELATED APPLICATIONS

This application claims priority under 35 U.S.C. 119(e) to U.S. Provisional Patent Application Ser. No. 61/470,522, entitled “Computer-Implemented Generation of Roadmap Visualizations”, filed on Apr. 1, 2011, which application is incorporated herein by reference in its entirety.

### COPYRIGHT STATEMENT

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND

The present invention relates generally to visualizations of business data, and more particularly to the computer-implemented generation of roadmap visualizations of business data.

In today's complex business world, managers are inundated with business data, and the volume and disparate form of such data makes it difficult to compare performance within a business entity and relative to other entities or industry standards. For example, a manager may desire to compare the information technology performance of various business divisions against each other and against industry standards, but may be required to analyze multiple reports in different formats to do so. Conventional methods of obtaining business data often rely on expensive consultants to interview employees, which disrupts employee workflow by removing employees from their job duties to meet with consultants, and which may result in the data being abstract, incomplete, or potentially skewed by consultant bias or unavailability of key personnel for interviews. Moreover, these conventional methods do little to solve the problems of data variety and volume.

### SUMMARY OF THE INVENTION

The present embodiments provides an integrated process whereby employees may participate in the process at their convenience, such as by taking surveys at their workstations, and whereby the results are assessed in a uniform manner to produce visualizations which summarize key data in a graphically expressive manner. The visualizations also provide “one-click” comparisons enabling managers to view their entity data against comparative data in the same visual format. The integration of the process also enables the construction of a real-world benchmark database whereby data from each entity utilizing the roadmap visualization service may be added to a benchmark database, thus allowing future comparisons to be made against real-world benchmarks.

Accordingly, embodiments of the present invention include a method, computer program product and a system for generating a roadmap visualization for a set of topics, comprising collecting topic data about each topic in a set of topics from an entity, analyzing the collected topic data to calculate one or more business scores for each topic, generating a visualization by plotting entity datapoints for each topic in a visualization format, where visual characteristics of the entity datapoints indicate the business scores for each topic, and displaying the visualization on a display device. The topics may relate to information technology, human resources, risk, audit, capital planning, research and development, or any other entity-related topic desired to be visualized, and the business scores may be any suitable information desired to be visualized, such as risk scores, business impact scores, implementation scores, uncertainty scores or alignment scores.

The above and still further features and advantages of embodiments of the present invention will become apparent upon consideration of the following detailed description thereof, particularly when taken in conjunction with the accompanying drawings wherein like reference numerals in the various figures are utilized to designate like components.

### BRIEF DESCRIPTION OF THE DRAWINGS

FIG. 1 is a block diagram illustrating an exemplary computer system according to an embodiment of the present invention.

FIG. 2 is a flowchart depicting an exemplary computer-implemented process of generating a roadmap visualization for a set of topics according to an embodiment of the present invention.

FIG. 3 is a flowchart depicting an exemplary process of roadmap creation and management services according to an embodiment of the present invention.

FIG. 4 is a flowchart depicting an exemplary process of managing a roadmap agenda according to an embodiment of the present invention.

FIG. 5 is a flowchart depicting an exemplary process of data collection according to an embodiment of the present invention.

FIGS. 6A and 6B are flowcharts depicting an exemplary process of working with visualizations according to an embodiment of the present invention.

FIGS. 7A through 7E are schematic diagrams depicting bullseye lifecycle change diagrams according to an embodiment of the present invention. FIGS. 7A through 7E are lined for color.

FIGS. 8A and 8B are schematic diagrams depicting endpoint lifecycle change diagrams according to an embodiment of the present invention. FIGS. 8A and 8B are lined for color.

FIGS. 9A and 9B are schematic diagrams depicting racetrack lifecycle change diagrams according to an embodiment of the present invention. FIGS. 9A and 9B are lined for color.

FIG. 10 is a schematic diagram depicting a Gantt chart evaluation diagram according to an embodiment of the present invention. FIG. 10 is lined for color.

FIG. 11 is a schematic diagram depicting a retirement risk matrix evaluation diagram according to an embodiment of the present invention. FIG. 11 is lined for color.

FIG. 12 is a flowchart depicting an exemplary process of defining data dependencies according to an embodiment of the present invention.

FIG. 13 is a schematic diagram depicting an exemplary process of defining data dependencies according to an embodiment of the present invention.

FIGS. 14A and 14B are schematic diagrams depicting two example float-over information windows according to an embodiment of the present invention. FIGS. 14A and 14B are lined for color.

Each drawing that is lined for color uses the same symbols to represent particular colors. The representations include: the color green represented by diagonal lining; the color yellow represented by cross-hatched lining; the color red represented by solid vertical lining; the color purple represented by dashed (broken) vertical lining; the color blue represented by solid horizontal lining; and the color gray represented by dashed (broken) horizontal lining.

### DETAILED DESCRIPTION

Reference will now be made in detail to the presently preferred embodiments of the invention, which, together with the drawings, serve to explain the principles of the invention. These embodiments are described in sufficient detail to enable those skilled in the art to practice the invention, and it is to be understood that other embodiments may be utilized, and that structural, electronic, and mechanical changes may be made without departing from the spirit and scope of the present invention. Unless otherwise defined, all technical and scientific terms used herein have the same meaning as commonly understood by one of ordinary skill in the art to which this invention belongs. Although any methods and materials similar or equivalent to those described herein can be used in the practice or testing of the present invention, the preferred methods, devices, and materials are now described.

A. Example System for Generating Roadmap Visualizations

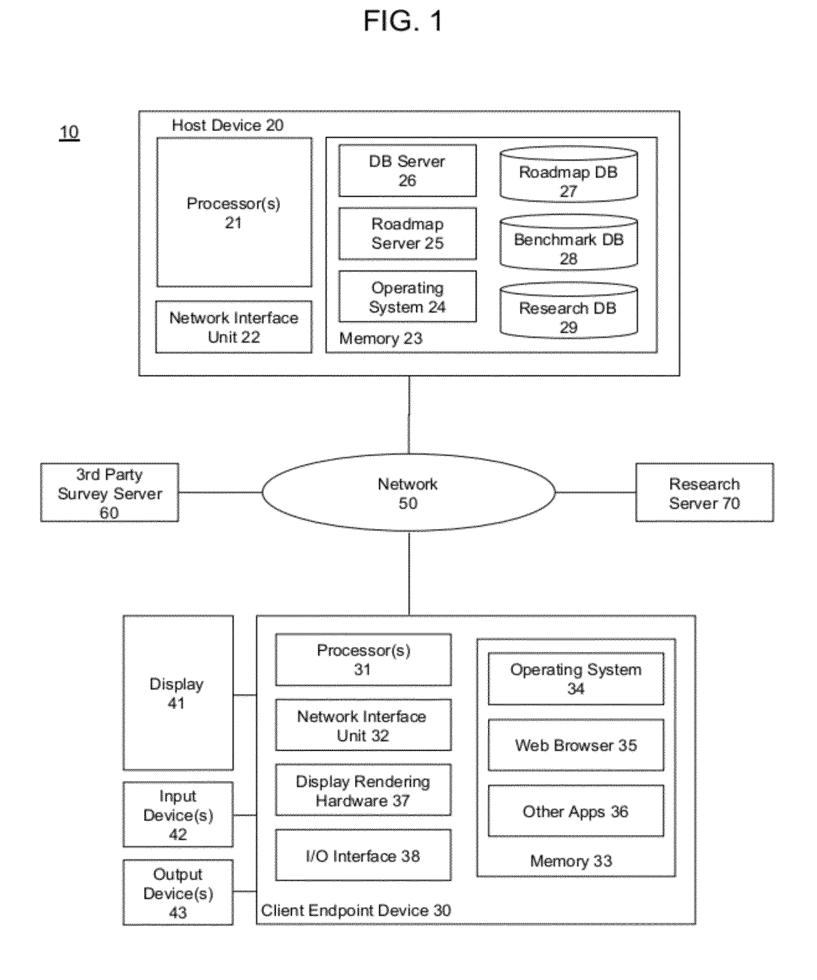

Referring now to the Figures, an example of a system in which the present embodiments may be implemented is shown in FIG. 1. The depicted system 10 includes host device 20, client endpoint device 30, third party survey server 60 and research server 70, which are connected over network 50 to each other. Host device 20 and client endpoint device 30 may each be implemented in the form of a processing system, or may be in the form of software. They can each be implemented by any quantity of conventional or other computer systems or devices, such as a computing blade or blade server, thin client, computer terminal or workstation, personal computer (e.g., IBM-compatible PC, Apple Mac, tablet, laptop, netbook, etc.), cellular phone or personal data assistant (e.g., Palm Pre, Droid, iPhone, etc.), or any other suitable device.

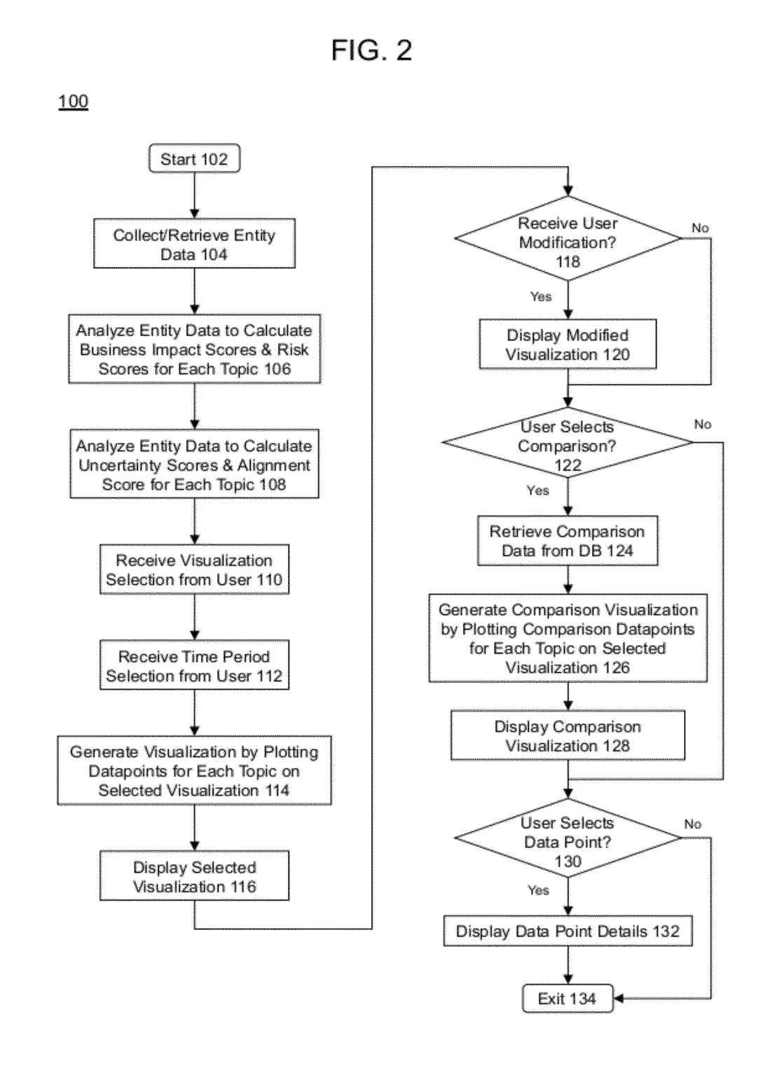

Host device 20 comprises one or more processors 21, a network interface unit 22, and memory 23, and client endpoint device 30 comprises one or more processors 31, a network interface unit 32, and memory 33. Resident in memory 23, 33 are respective operating systems 24, 34. The processors 21, 31 are, for example, data processing devices such as microprocessors, microcontrollers, systems on a chip (SOCs), or other fixed or programmable logic, that executes instructions for process logic stored in memory 23 or 33, respectively. The network interface units 22, 32 enable communication throughout system 10. Memory 23, 33 may be implemented by any conventional or other memory or storage device, and may include any suitable storage capacity. For example, memory 23, 33 may comprise read only memory (ROM), random access memory (RAM), erasable programmable read-only memory (EPROM), magnetic disk storage media devices, optical storage media devices, flash memory devices, electrical, optical, or other physical/tangible memory storage devices. The memory 23, 33 may comprise one or more computer readable storage media (e.g., a memory device) encoded with software comprising computer executable instructions and when the software is executed (by processor 21 or 31) it is operable to perform the operations described herein in connection with FIGS. 2-6 and 12. Operating systems 24, 34 may be any conventional or other operating system suitable for use in system 10 (e.g., AIX, Android, Linux, OSX, Sun Solaris, Unix, Windows, etc.).

Resident in memory 23 on host device 20 are roadmap server 25, database server 26, roadmap database 27, benchmark database 28 and research database 29. Roadmap server 25 may be any suitable server for providing roadmapping services to users of client endpoint devices 30. Database server 26 may be any database server suitable for providing database services to other applications, computers, clients 5, etc. Roadmap database 27 may be used to store visualizations, reports, and customer data such as lists of authorized users and superusers, benchmark database 28 may be used to store survey data, industry data, and industry standards that are used for benchmarking and comparative purposes, and research database 29 stores research information such as research papers, white papers, trends papers, news articles, etc. These databases may be any suitable database, for example a relational database, an XML database, or any other suitable format for storing data, and may be stored in any suitable fashion, such as in tables, indices, and the like.

Client endpoint device 30 further comprises a web browser 35 and optionally other applications 36 resident in memory, as well as display rendering hardware 37, input/output interface 38, a display device 41, input device(s) 42 and output device(s) 43. The web browser 35 provides an interface such as a graphical user interface (GUI) for a user of the client device 5 to interact with the roadmap server 25, for example to create a survey or a visualization. Other applications 36 may include any other desirable applications, such as a word processing program, email application, or the like. Display rendering hardware 37 may be a part of processor 31, or may be, e.g., a separate Graphics Processor Unit (GPU). I/O interface 38 enables communication between display device 41, input device(s) 42, output device(s) 43, and the other components of client device 5, and may enable communication with these devices in any suitable fashion, e.g., via a wired or wireless connection. The display device 41 may be any suitable display, screen or monitor capable of displaying information to a user of a client device 5, for example the screen of a tablet or the monitor attached to a computer workstation. Input device(s) 42 may include any suitable input device, for example, a keyboard, mouse, trackpad, touch input tablet, touch screen, camera, microphone, remote control, speech synthesizer, or the like. Output device(s) 43 may include any suitable output device, for example, a speaker, headphone, sound output port, or the like. The display device 41, input device(s) 42 and output device(s) 43 may be separate devices, e.g., a monitor used in conjunction with a microphone and speakers, or may be combined, e.g., a touchscreen that is a display and an input device, or a headset that is both an input (e.g., via the microphone) and output (e.g., via the speakers) device.

Third party survey server 60 may be one or more servers operated by a third party that conducts surveys and collects data, for example the server of a company such as SurveyMonkey, SurveyTool, Zoomerang, etc. Research server 70 may be one or more servers which comprise data such as industry data, industry standards, research papers, white papers, trends papers, news articles, etc.

The components of system 10 are communicatively connected to each other, for example, via network 50, which represents any hardware and/or software configured to communicate information via any suitable communications media (e.g., WAN, LAN, Internet, Intranet, wired, wireless, etc.), and may include routers, hubs, switches, gateways, or any other suitable components in any suitable form or arrangement. The various components of the system 10 may include any conventional or other communications devices to communicate over the network 50 via any conventional or other protocols, and may utilize any type of connection (e.g., wired, wireless, etc.) for access to the network.

The system 10 may include additional servers, clients, and other devices not shown, and individual components of the system may occur either singly or in multiples, for example, there may be more than one host device 20 or client device 30 in the system, or for example, the functionality of various components (e.g., roadmap database 27 and benchmark database 28) may be combined into a single device or split among multiple devices. It is understood that any of the various components of the system 10 may be local to one another, or may be remote from and in communication with one or more other components via any suitable means, for example a network such as a WAN, a LAN, Internet, Intranet, mobile wireless, etc.

B. Example Process for Generating Roadmap Visualizations

Referring now to FIG. 2, reference numeral 100 generally designates a flowchart depicting an exemplary computer-implemented process of generating a roadmap visualization for a set of topics according to an embodiment of the present invention, which may be carried out by the host device 20 previously described, and in particular by the roadmap server 25 in conjunction with other components.

The process 100 starts at step 102, and in step 104 the roadmap server 25 collects or retrieves entity data, for example by conducting a survey or by retrieving survey data from a database. An entity may be, e.g., a company or organization, one or more business units or departments within the company, or one or more locations. The survey inquires about various topics, which may be any desired topic depending on what a particular entity is interested in visualizing with the present embodiments. For example, the roadmapping process may be used to visualize information technology topics, such as software implementation, networking techniques, device support, etc., human resources topics, such as employee retention, workplace diversity, training programs, etc., risk-related topics, audit-related topics, capital planning topics, research and development topics, etc.

The survey data may, for example, comprise one or more user responses to one or more questions about one or more topics. Thus, for example, the survey data for a particular entity may comprise multiple user's responses to questions regarding various aspects of the topics, such as the current implementation of the topic, the desired implementation phase of the topic, the estimated business impact of a particular topic, the risk of implementing a particular topic, the preparedness of the company with regard to a particular topic, etc. For example, if the survey topics are information technology topics, and one such topic is the implementation of cloud data storage, then the survey data may comprise multiple user's responses to questions regarding how the entity is currently implementing cloud data storage, the estimated risk of such implementation, the business impact (e.g., expenses or savings associated with implementation) of cloud data storage, etc. The survey data may comprise numerical responses (e.g., questions answered on a scale of 1 through 5 points) or may comprise textual responses that are converted to numerical scores using, e.g., a conversion framework such as the Apache UIMA framework, which has components that use tools such as text-chunking, recognizing named entities, relating synonyms, etc., to convert unstructured text into a structured format, from which it may be scored.

In step 106 the roadmap server 25 analyzes the entity data to calculate one or more business scores, for example by running the survey data through one or more algorithms or scoring methods. Any suitable scoring method may be used, for example, each possible response to a particular question may be assigned a particular value (e.g., 1 through 5 points) and certain questions may be assigned more weight than other questions (e.g., question 2 may be assigned 2× weight, question 3 may be assigned 4× weight, etc.), certain users may be assigned higher or lower weights for certain topics than others (e.g., a computer network administrator may be assigned 3× weight for questions regarding networking technologies, but 0.5× weight for questions regarding employee retention strategies). The scoring methods may be customized for a particular entity, set of topics, or industry, or may be a standardized scoring method. The business scores may be any suitable information desired to be visualized for a particular topic or set of topics, such as risk scores, business impact scores, implementation scores, uncertainty scores or alignment scores.

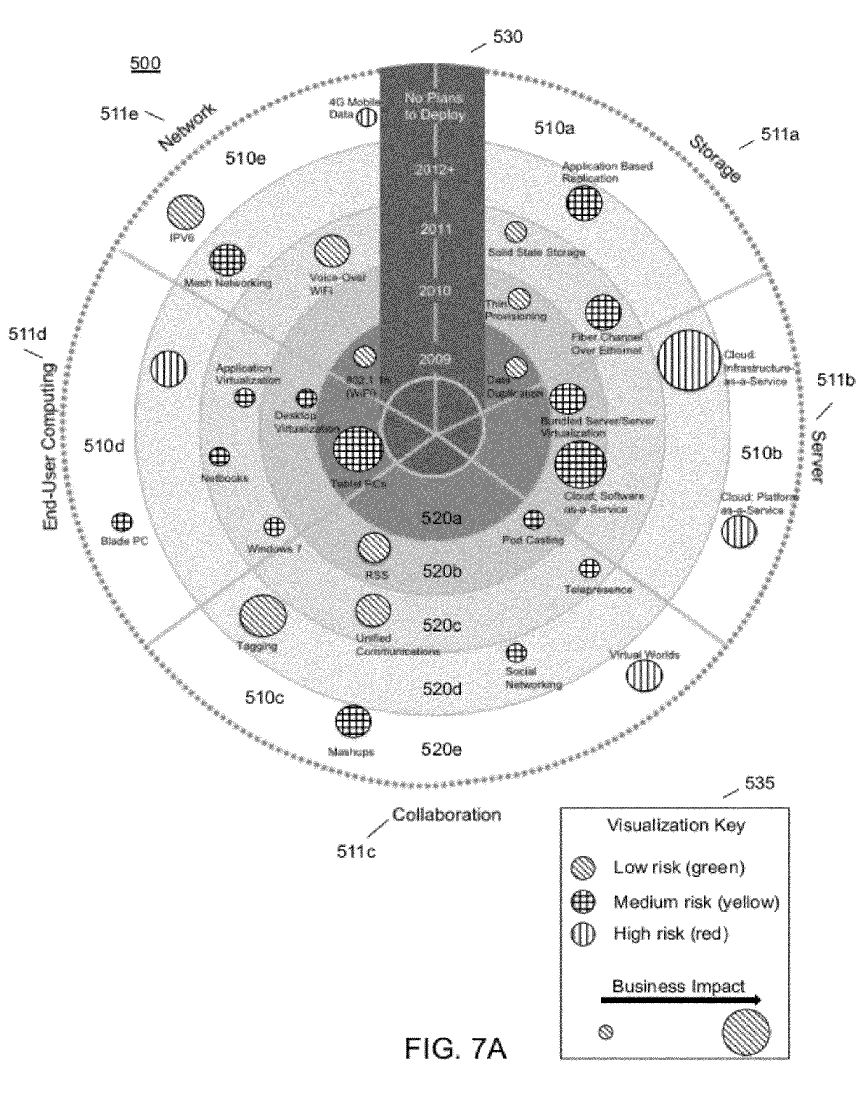

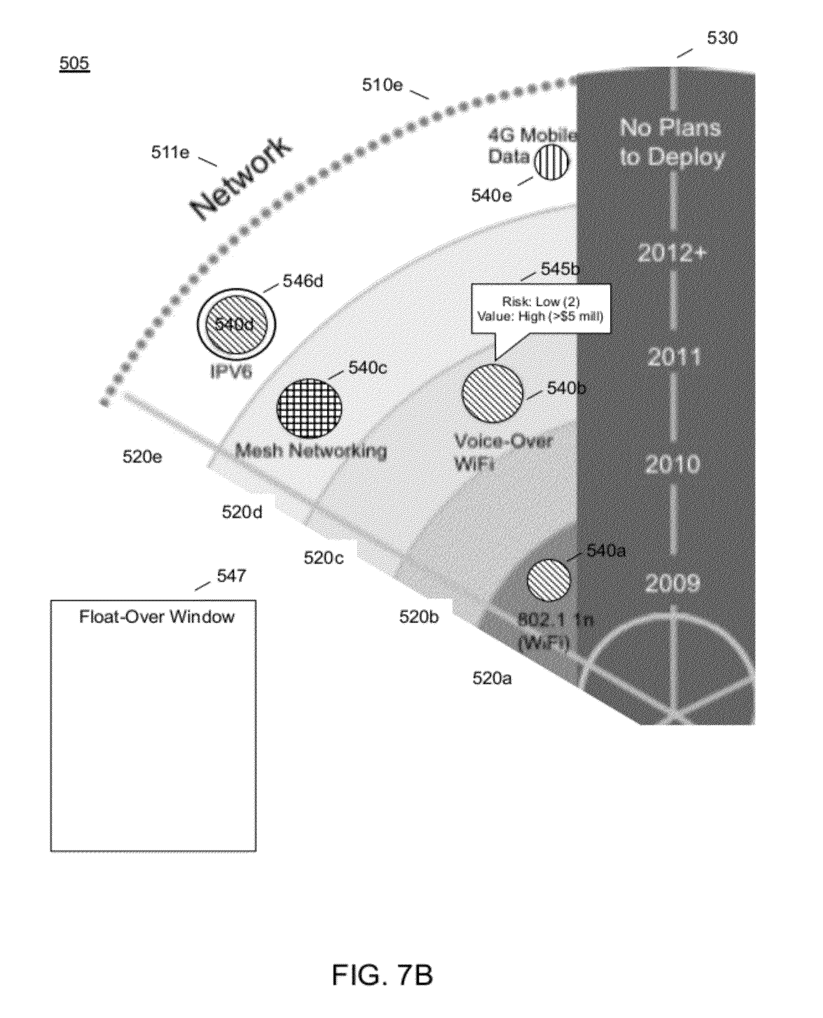

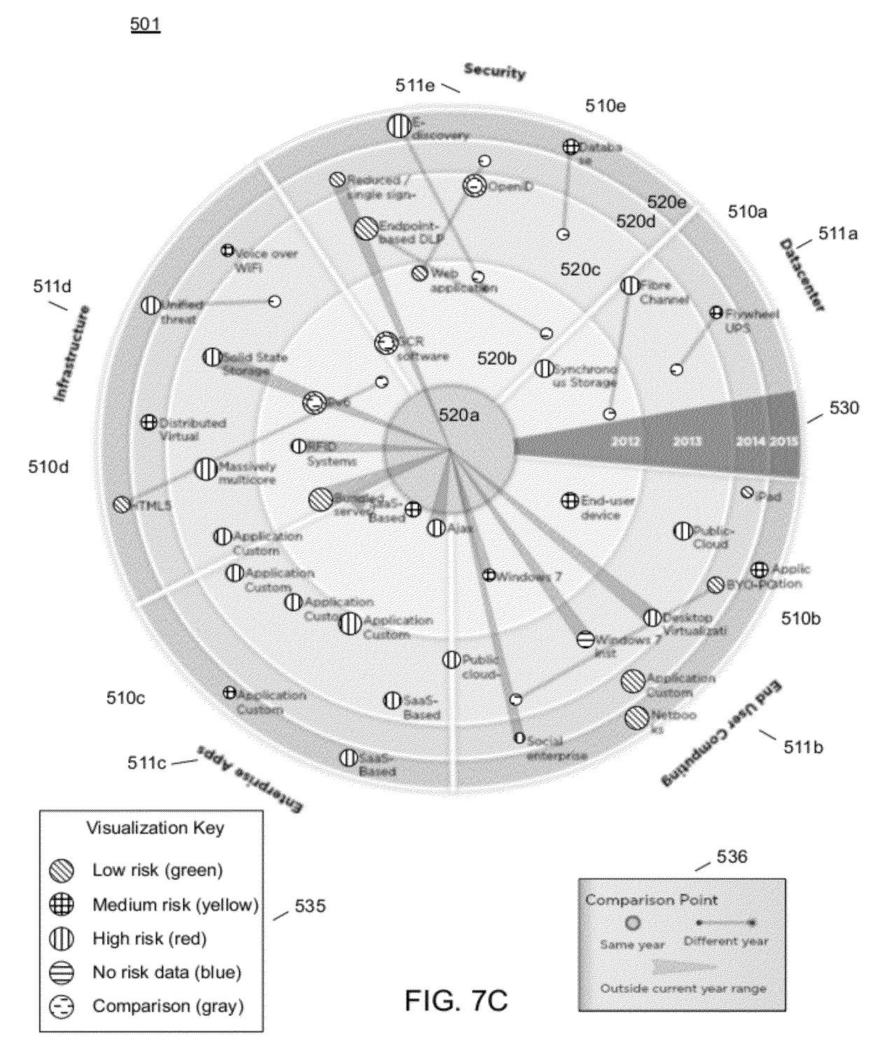

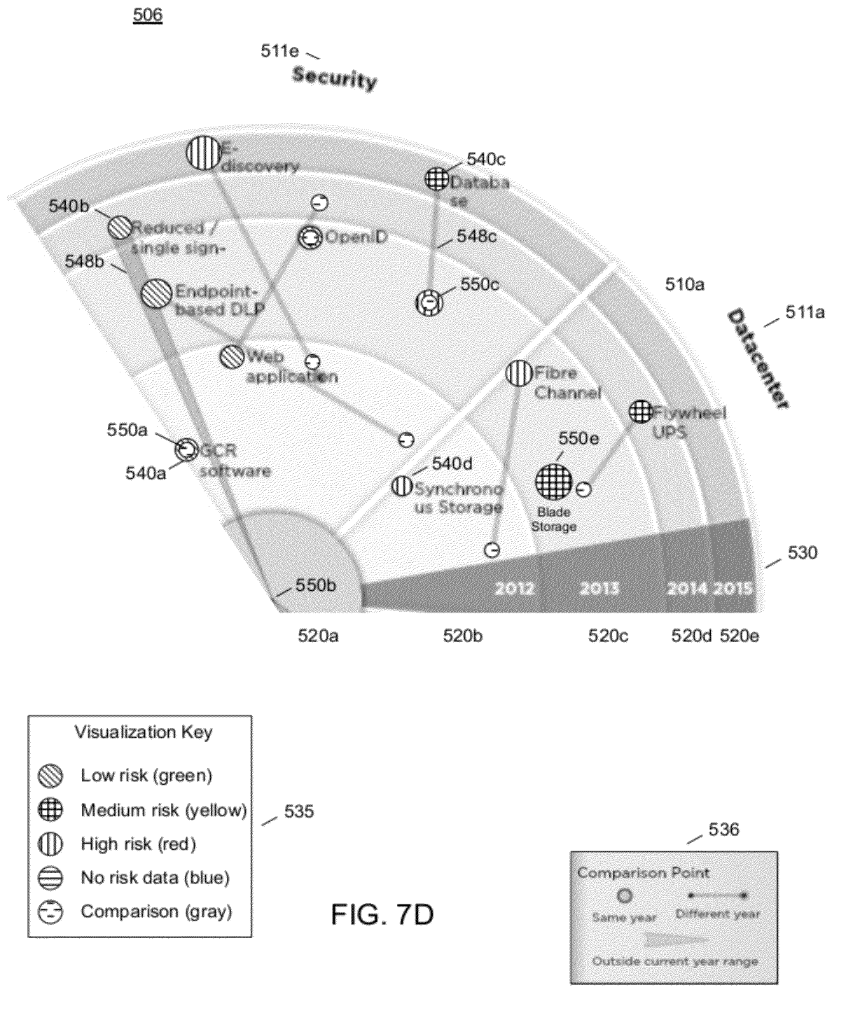

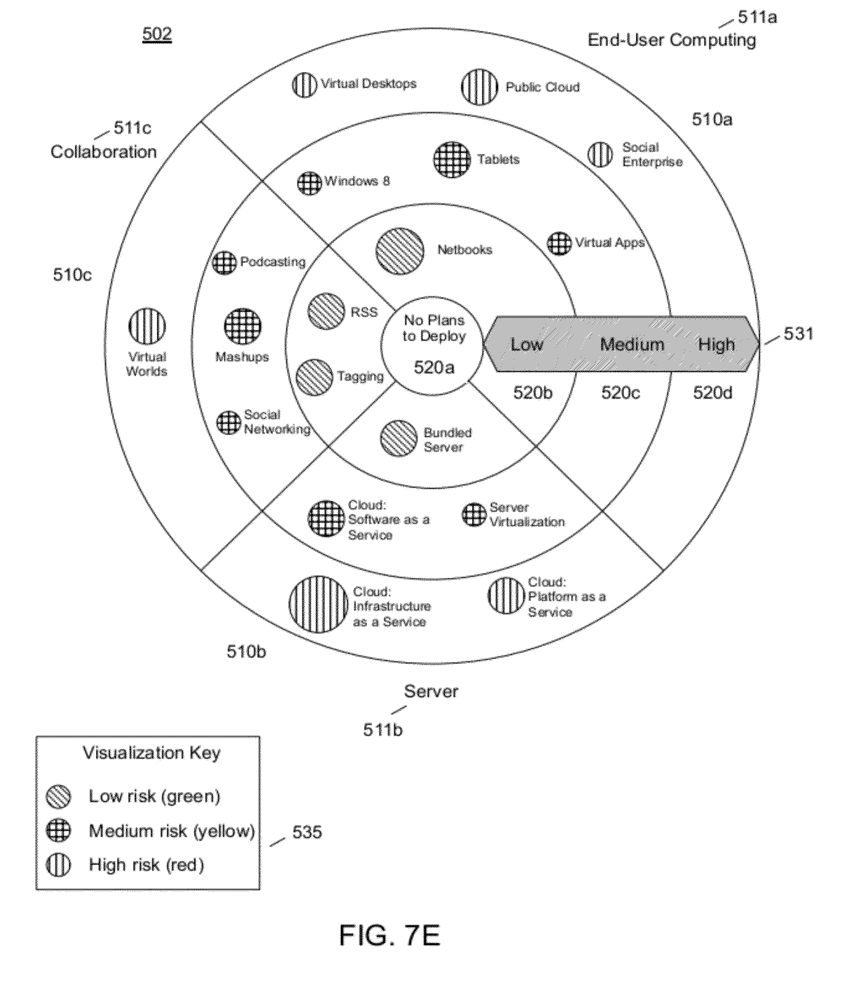

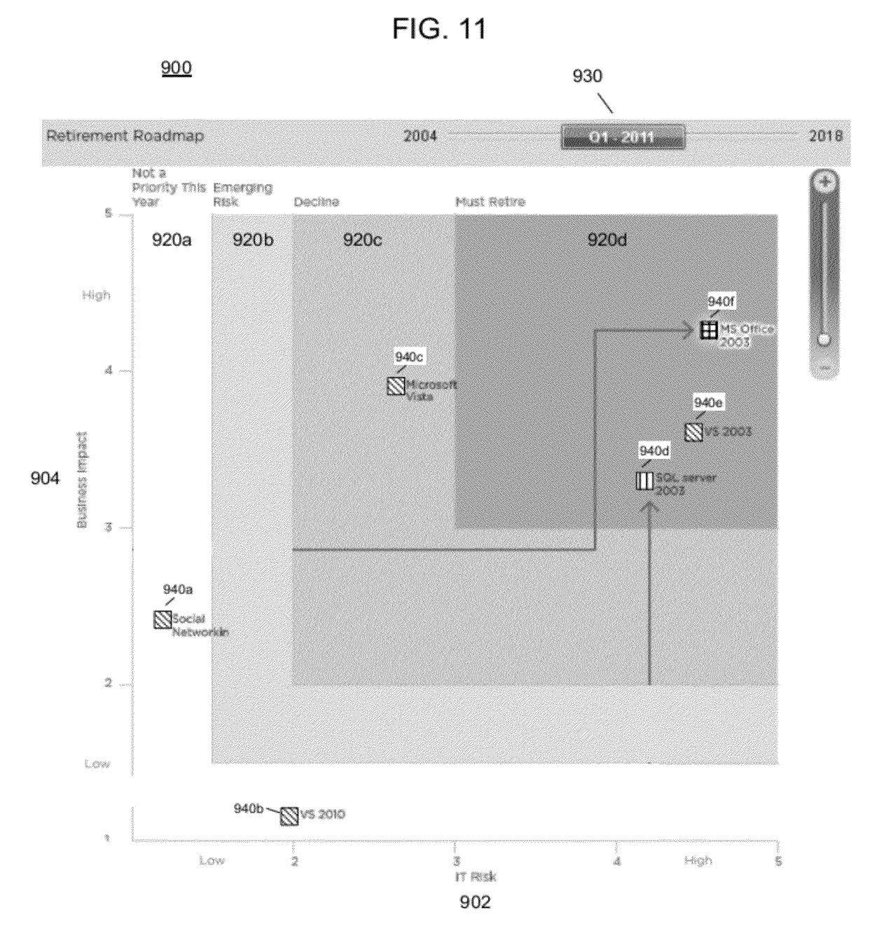

In step 108 the roadmap server 25 analyzes the entity data to calculate uncertainty scores and alignment scores for each topic. Uncertainty and alignment scores may be calculated using statistical formulations, for example by using conventional statistical models, or by customized methods as desired for a particular entity, set of topics, or industry. In step 110 the roadmap server 25 receives a visualization selection from a user, for example by the user selecting a lifecycle change diagram such as a bullseye diagram (depicted in FIGS. 7A through 7E), or an evaluation diagram such as a retirement risk matrix (depicted in FIG. 11). In step 112 the roadmap server 112 receives a time period selection from the user, and in step 114 generates the selected visualization by plotting datapoints for each topic in an appropriate visualization format, for example by plotting the datapoints in a bullseye format if a bullseye diagram has been selected. In step 116 the roadmap server 25 displays the selected visualization, for example by displaying it on display device 41 so that a user may view it.

The user may manipulate the displayed visualization in various ways, for example by modifying or filtering data points, adding comparison data, or selecting a data point to obtain further information. Comparisons may be made to other industries (for example, industries having a different Standard & Poors Global Industry Classification than the entity), specific peer or competitor entities, entities having similar capitalization or market share, industry standard data, etc. Comparisons may also be made intra-entity, for example data from multiple different departments or office locations may be compared simultaneously.

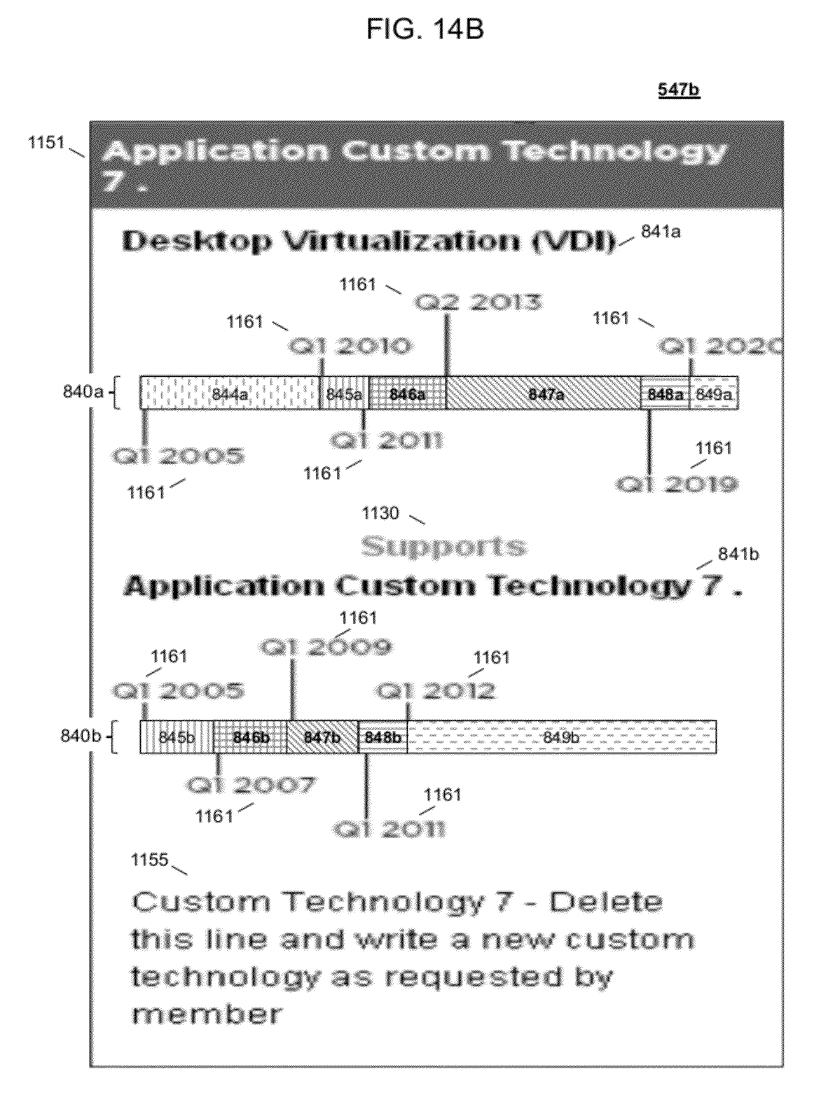

For example, in step 118 if the roadmap server 25 receives a user's modification, it processes the modification, for example by filtering out certain data points, and then displaying the modified visualization in step 120. In step 122, if the roadmap server 25 receives a user's selection of a comparison, then in step 124 the server retrieves the comparison data from a database, for example the benchmark database 28, and in step 126 generates the comparison visualization by plotting comparison datapoints for each topic on which comparison data is desired and available on the selected visualization. In step 128 the roadmap server 25 displays the comparison visualization, for example by displaying it on display device 41 so that a user may view it. Exemplary comparison visualizations are shown in FIGS. 7C, 7D, 8B, and 9B. The user may also select a datapoint, for example by clicking on it or hovering over it, and in step 130 if the roadmap server 25 receives such a selection, then in step 132 the server displays details about the datapoint, for example in a pop-up box or float-over window (as shown in FIGS. 7B, 14A and 14B), before exiting the process at step 134.

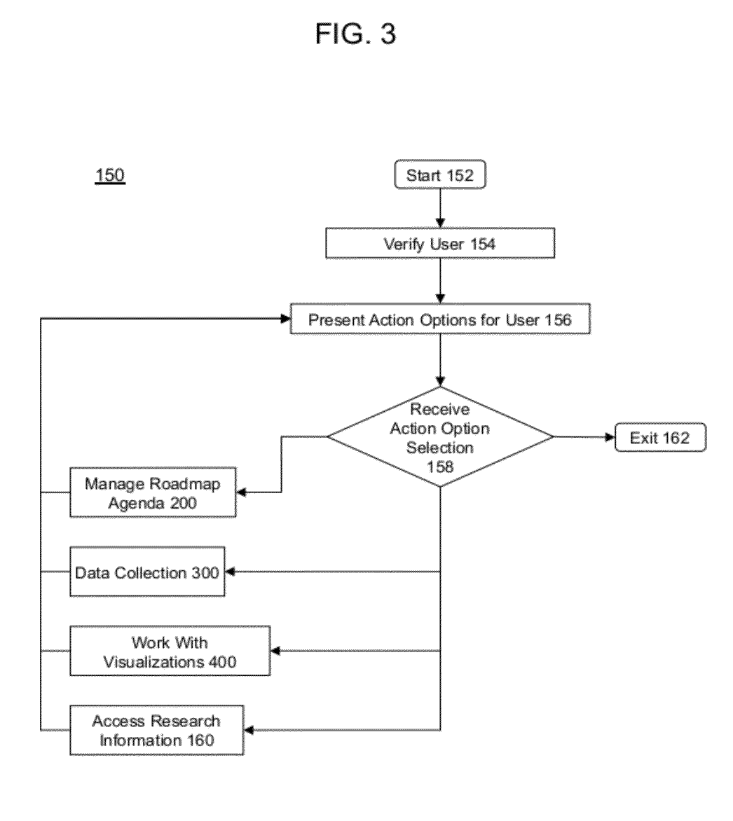

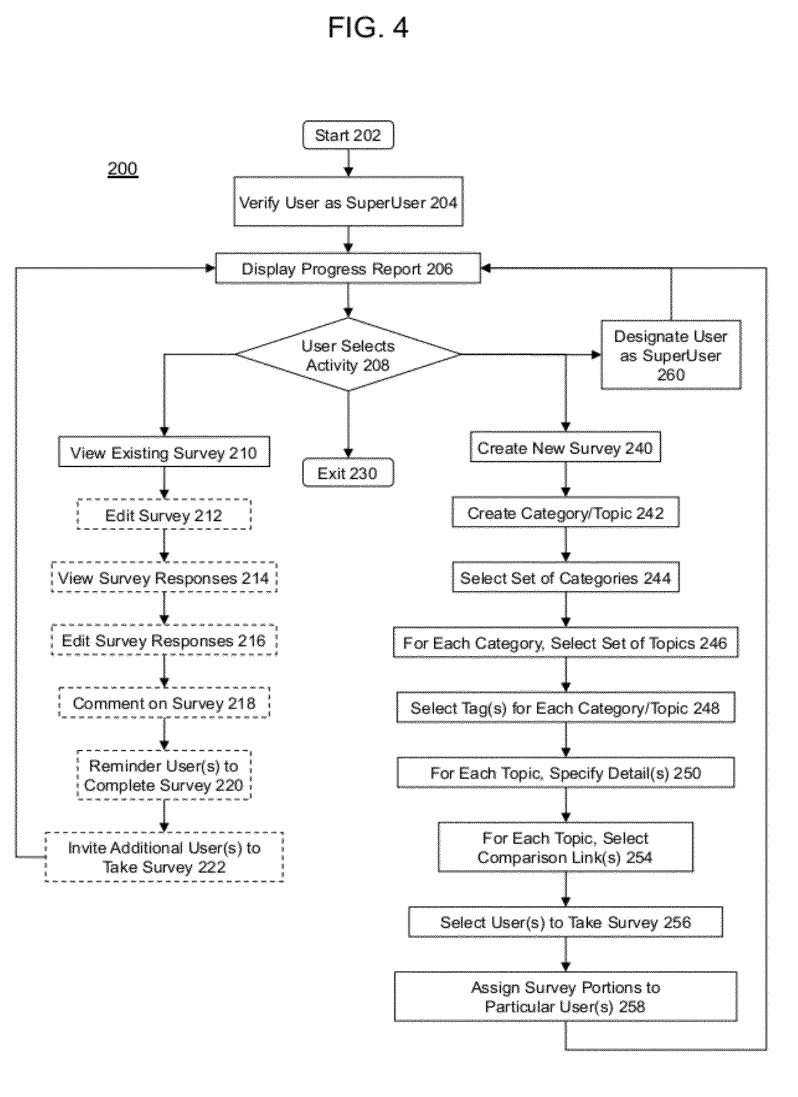

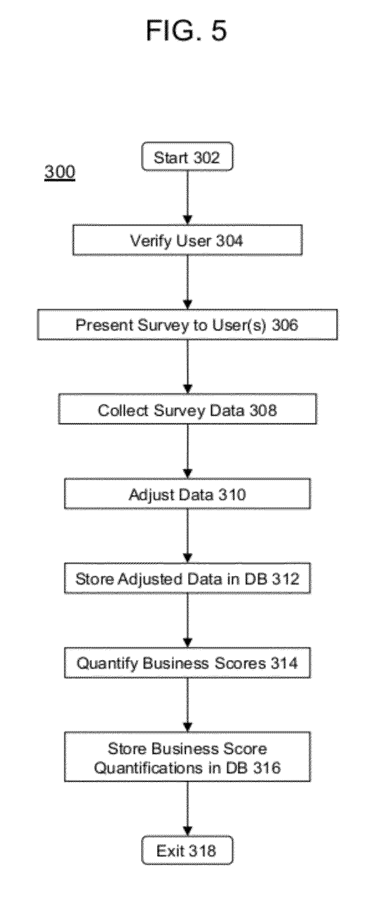

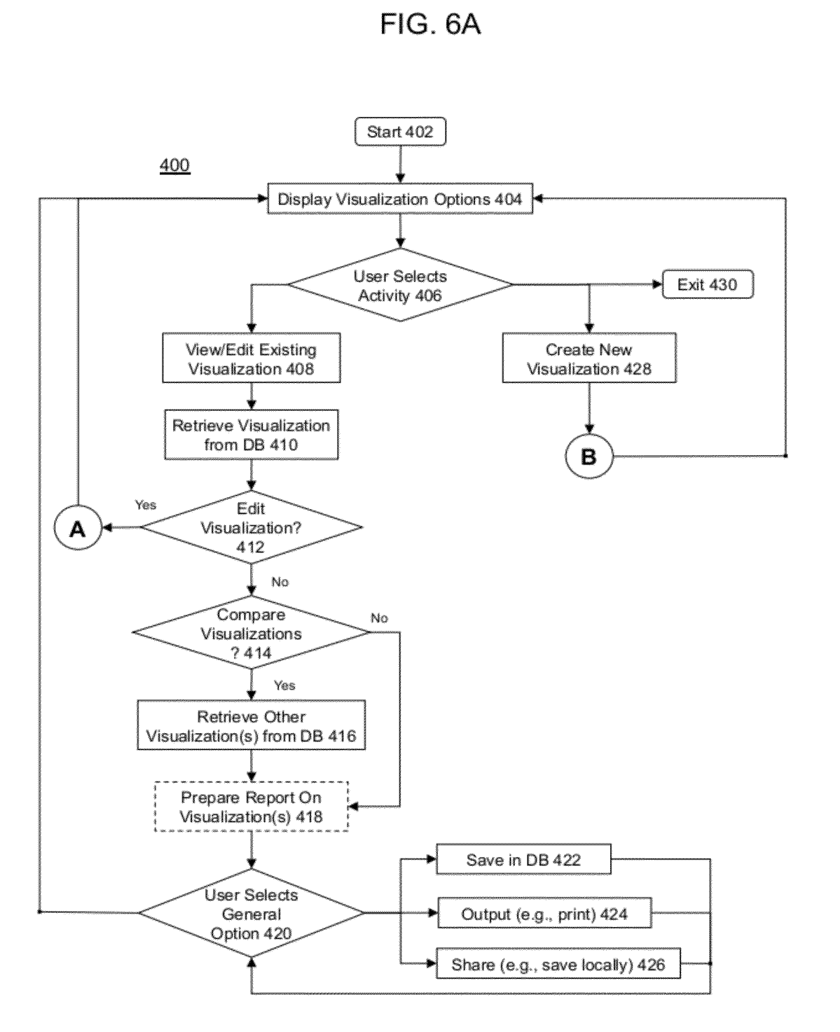

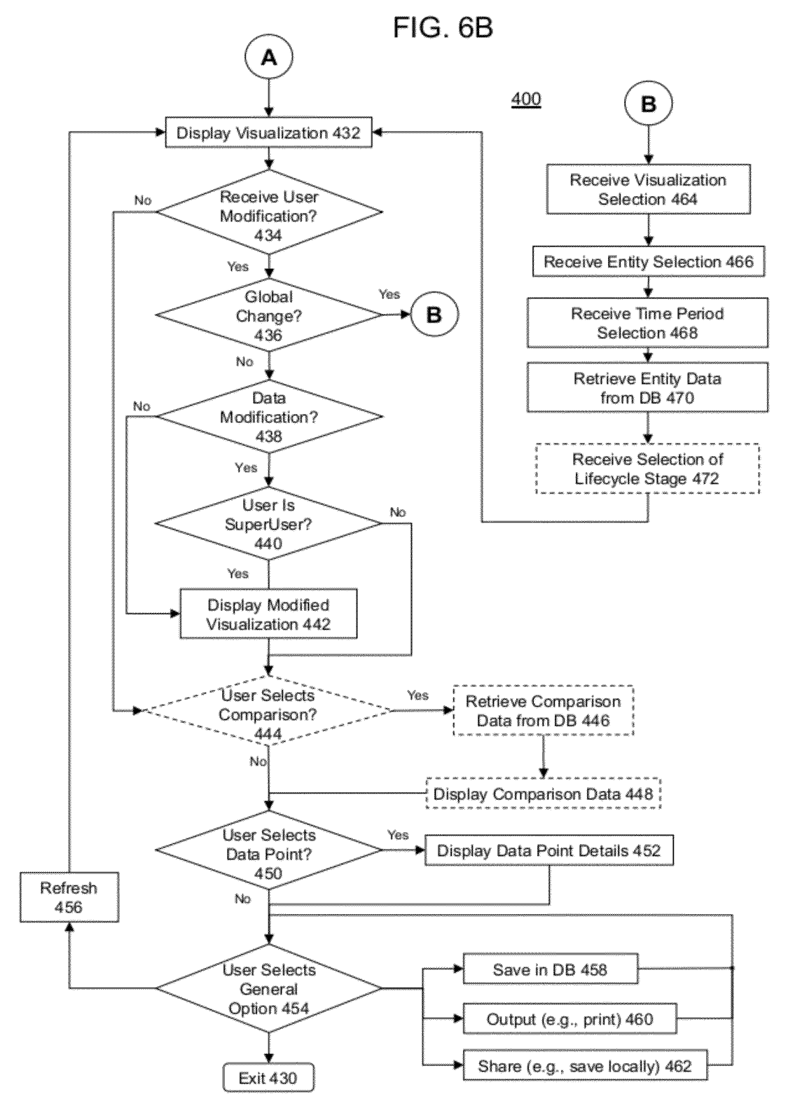

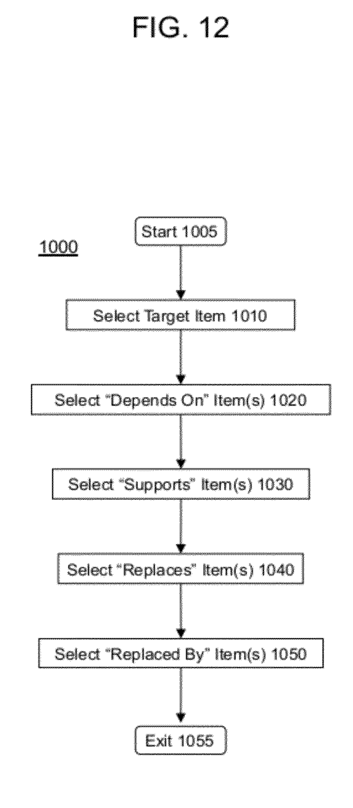

This general process may be further understood by the additional processes described herein, such as the exemplary process of roadmap creation and management services described with reference to FIG. 3, the exemplary process of managing a roadmap agenda described with reference to FIG. 4, the exemplary process of data collection described with reference to FIG. 5, the exemplary process of working with visualizations described with reference to FIGS. 6A and 6B, and the exemplary process of defining data dependencies described with reference to FIG. 12. Although some of these processes depicted in FIGS. 3 through 6 and 12 are depicted from the user's viewpoint and some are depicted from the viewpoint of the roadmap server 25, it is understood that all of the processes herein are computer-implemented. Thus, for example, when step 240 of FIG. 4 is described as the user creating a new survey, it is understood that this is merely a short-hand description of the user, e.g., utilizing web browser 35 on client endpoint device 30 to interface with roadmap server 25 in order to create a new survey by selecting various options presented to the user by the roadmap server 25.

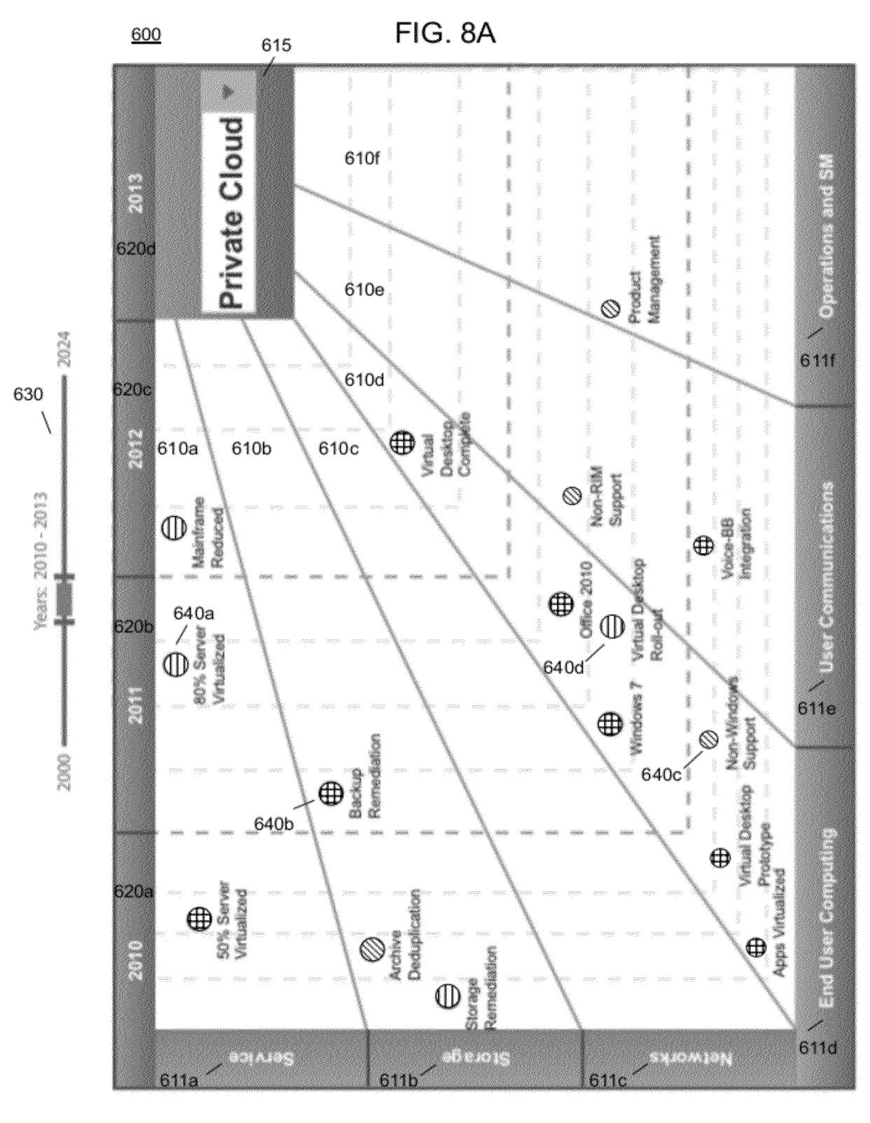

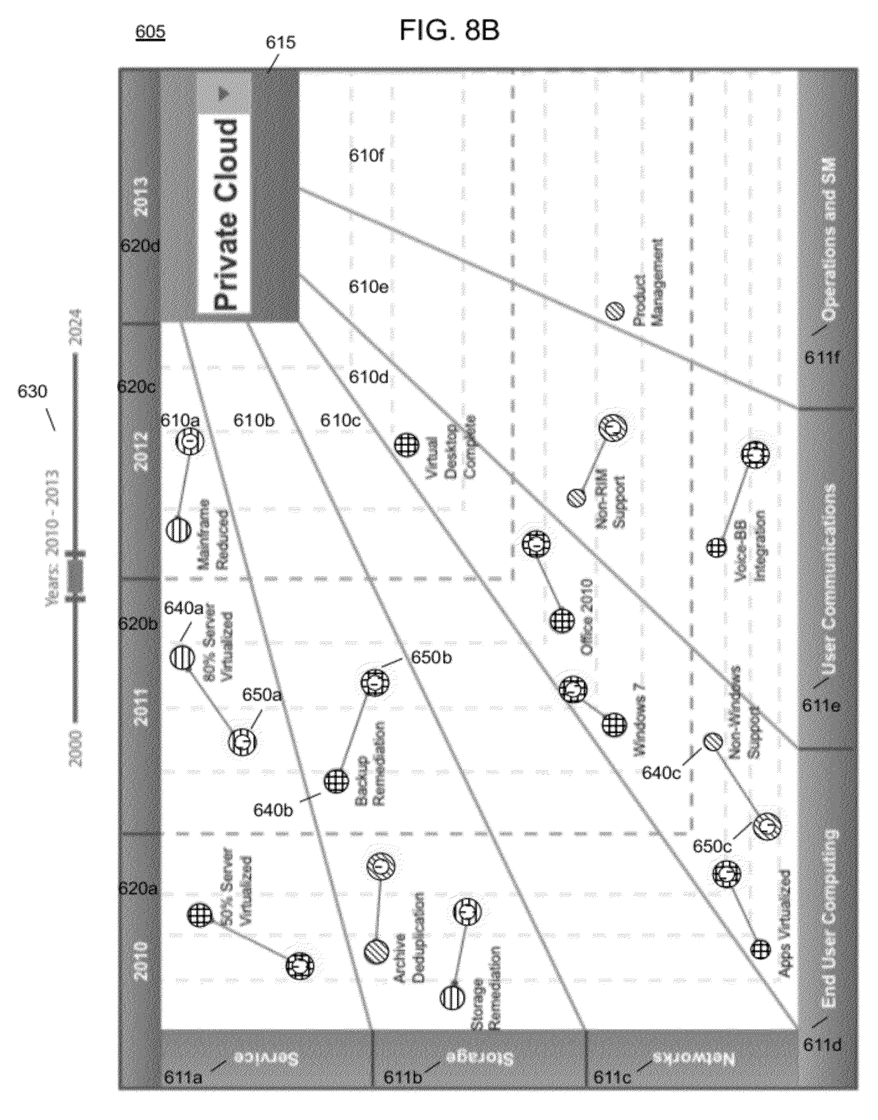

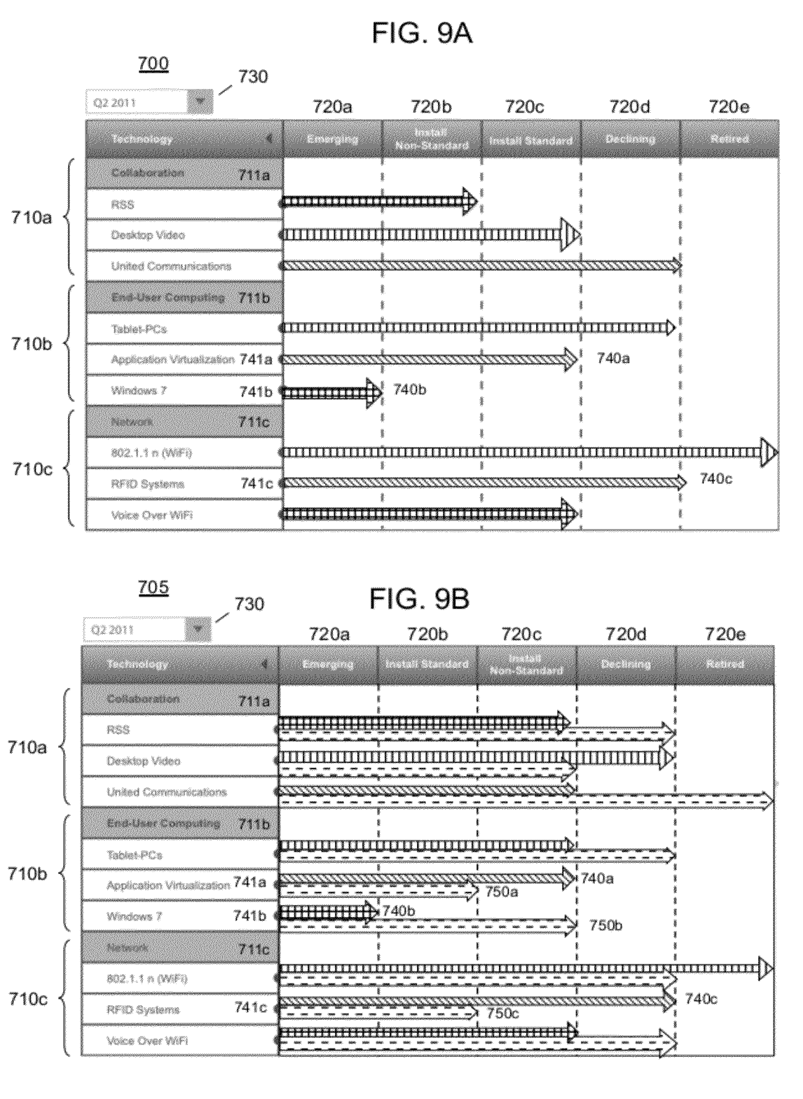

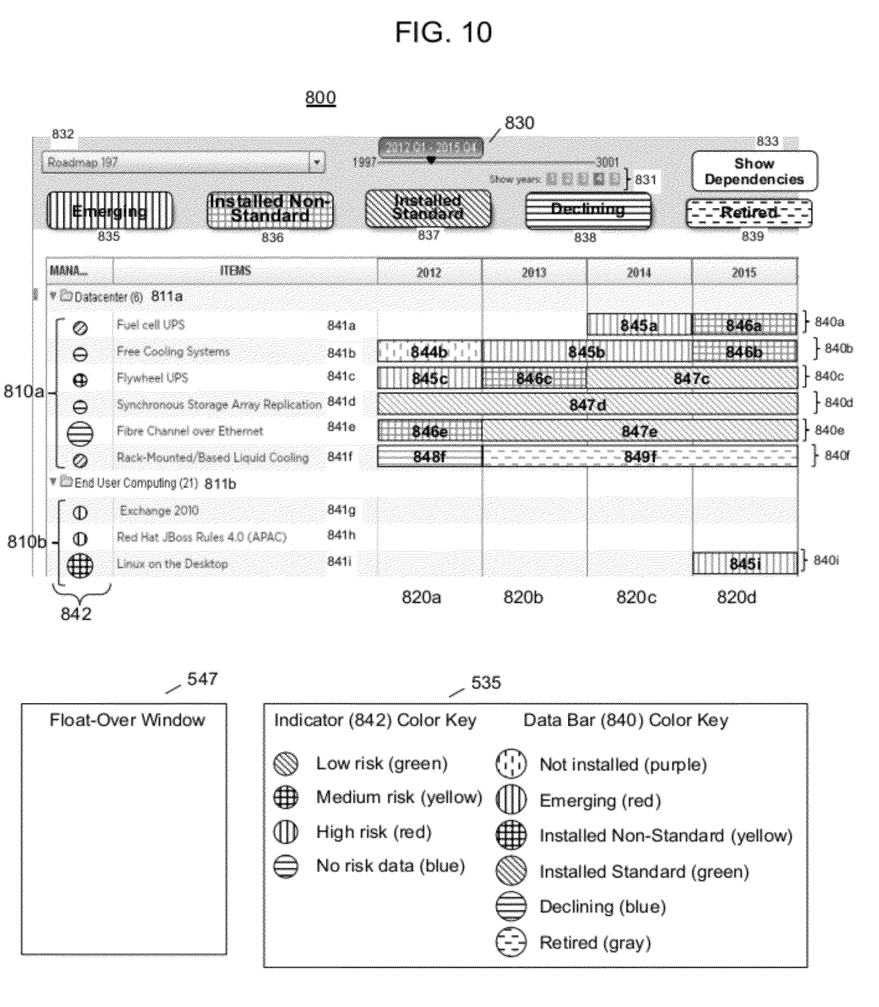

The various visualizations depicted and described herein are exemplary, and it is understood that other visualizations may be used with the processes and systems described herein. The exemplary depicted visualizations are of two primary types, lifecycle change diagrams, and evaluation diagrams. Lifecycle change diagrams, such as the bullseye diagram (depicted in FIGS. 7A through 7E), end-point diagram (depicted in FIGS. 8A and 8B), or racetrack diagram (depicted in FIGS. 9A and 9B), are used to depict an entire category and topic lifecycle, allowing a user to quickly identify time periods or categories that are relatively high risk, or to compare an entity's current plans to industry benchmarks or past plans. Evaluation diagrams, such as the Gantt chart (depicted in FIG. 10) or retirement risk matrix (depicted in FIG. 11), are used to provide detailed information about technology lifecycle planning risks. Each of these diagrams has a characteristic format, for example the bullseye diagram is depicted as a series of concentric rings representing various time periods, as intersected by categories of topics, and the Gantt chart diagram is depicted as a form of table in which the rows represent various topics, and the columns represent various time periods.

The datapoints plotted in the visualization format have visual characteristics that indicate the business scores for each topic, e.g., the risk score and business impact score. For example, the datapoints may comprise at least two visual characteristics: location and size, where the location of the datapoint indicates a corresponding time period, time point, maturity level, or implementation phase, and where the size of the datapoint indicates a relative business impact (value) as compared to other datapoints. The datapoints may comprise additional visual characteristics, for example a shape or color, which may indicate the relative risk score, for example green for low risk, yellow for medium risk, and red for high risk. Uncertainty scores may also be depicted, for example by indicating the margin of error by showing a halo around the datapoint, by changing the color of the datapoint, etc. In other diagrams, for example a Gantt chart, color may be used in a different fashion, such as to illustrate the phase of a particular topics, e.g., blue for an emerging phase, green for a core phase, yellow for a declining phase, and red for a retired phase.

Referring now to FIG. 3, reference numeral 150 generally designates a flowchart depicting an exemplary process of roadmap creation and management services according to an embodiment of the present invention, which may be carried out by the host device 20 previously described, and in particular by the roadmap server 25 in conjunction with other components. The process starts at step 152, for example by a user of a client device 30 logging onto a web interface in order to create or manage a roadmap. In step 154, the host device 20 verifies that the user is authorized to access the system, and in step 156 presents action options to the user.

In step 158, the roadmap server 25 receives a user's selection of an action option, for example manage a roadmap agenda 200, where the user may create or edit a survey, view and comment on survey results, assign survey portions to be taken by particular users/groups, etc., as is further described with reference to process 200 and FIG. 4. Another action option is data collection 300, where the user may take a survey, and the system may process survey data, as is further described with reference to process 300 and FIG. 5. Another action option is to work with one or more visualizations, for example by creating, viewing, editing, comparing, printing, etc. a new or existing visualization, as is further described with reference to process 400 and FIG. 6. The user may also select to access research information at step 160, or to exit the process at step 162. After any of these action options, other than exiting the process, the user is returned to step 156, where the roadmap server 25 presents actions for the user.

Referring now to FIG. 4, reference numeral 200 generally designates a flowchart depicting an exemplary process of managing a roadmap agenda according to an embodiment of the present invention, which may be carried out by the host device 20 previously described, and in particular by the roadmap server 25 in conjunction with other components.

The process starts at step 202, for example by a user of a client device 30 selecting the action option of managing a roadmap agenda once they have logged onto the system. In step 204, the system verifies that the user is a superuser with permission to access the management aspects of the system, and in step 206 the system presents a progress report to the user. The progress report may, e.g., display the status of a particular survey in terms of users who have completed the survey or the percentage of the survey that is in progress or completed. In step 208, the roadmap server 25 receives a user's selection of an action option, for example to view an existing survey 210, exit 230, create a new survey 240, or manage other users 260, for example by designating another user as a superuser.

If the user selects to view an existing survey (step 210), then the user may be presented with several more options. For example, in step 212 the user may select to edit the existing survey, for example by adding or deleting a question. In step 214 the user may view the survey responses received to date, and in step 216 may edit the responses, for example by removing an outlying value, adjusting an error in a survey response, or the like. In step 218 the user may comment on the survey, for example by adding a comment to a particular user's response or to a particular question. In step 220, the user may send a reminder to one or more users to complete a survey that they have been assigned but have not yet completed. In step 222, the user may evaluate the users who have been assigned to take a survey and may add additional users to the list of desired survey respondents.

If the user selects to create a new survey (step 240), then the system in step 242 presents the user with the option to create categories and topics for inclusion in the survey. For example, if the survey is about information technology, the user may create categories such as networking, collaboration, or end-user computing, and within the categories may create topics such as brand names of software or hardware, dependencies, information technology phases, and various tags. In step 244 the user may select a set of categories to include in the survey, and in step 246 for each category the user may select a set of topics. In step 248, the user selects one or more tags for each category and/or topic that has been selected.

In step 250, the user specifies one or more details for each topic. A detail can be any relevant type of information, for example a lifecycle date, a current status (e.g., implemented, retired, etc.), or a dependency. Each of these details can be specified by a particular process, for example if a dependency is defined, the user may be directed to process 1000 depicted in FIG. 12 to perform a process of defining the dependencies, before returning to process 200 at step 250. In step 254, the user selects one or more comparison links for each topic, and then the system creates the survey. In step 256 the user selects one or more users to take the survey, for example by selecting the users from a list. In step 258 the user may go through the list of selected users and designate particular survey portions to be completed by particular users.

In step 260, the user may designate one or more users as a superuser, i.e., a user with permission to create or edit surveys. The user may also select to exit the process at step 230. After any of these action options, other than exiting the process, the user is returned to step 206, where the roadmap server 25 presents actions for the user.

Referring now to FIG. 5, reference numeral 300 generally designates a flowchart depicting an exemplary process of data collection 300, where the user may take a survey, and the system may process survey data according to an embodiment of the present invention, which may be carried out by the host device 20 previously described, and in particular by the roadmap server 25 in conjunction with other components.

The process starts at step 302, for example by a user of a client device 30 selecting the action option of data collection once they have logged onto the system. In step 304, the system verifies that the user is permitted to take the survey, and in step 306 presents the appropriate survey or surveys to the user. In the case where a third-party survey server 60 is employed, the system may provide the user with a link to the appropriate web site on which the user may take the survey. In step 308, the system collects the survey data from completed surveys, and in step 310 adjusts the data as needed, for example by checking it, normalizing it, etc. In step 312 the system stores the adjusted data in the benchmark database 28, and quantifies the business scores from the survey results, for example by calculating business impact, risk, uncertainty and alignment scores based on the survey results. In step 316, the system stores the business scores in a database, such as benchmark database 28. The roadmap server then exits the process in step 318.

Referring now to FIGS. 6A and 6B, reference numeral 400 generally designates a flowchart depicting an exemplary process of working with visualizations 400 according to an embodiment of the present invention, which may be carried out by the host device 20 previously described, and in particular by the roadmap server 25 in conjunction with other components. The process starts at step 402, and in step 404 presents visualization options to the user. In step 406, the roadmap server 25 receives a user's selection of an action option, and in step 408 may view and/or edit an existing visualization, in step 428 create a new visualization, or in step 430 exit the process.

In step 408, the user selects to view or edit an existing visualization, for example by browsing to a saved visualization file. In step 410, the system retrieves the selected visualization from the appropriate database, for example roadmap database 27. In step 412, if the user selects the edit the visualization, then the system routes the user through point A to step 432 (as shown in FIG. 5B), and if not, the system routes the user to step 414. In step 414, if the user selects to compare the existing visualization with another visualization(s), then the system proceeds to retrieve the other visualization(s) from the appropriate database, and then proceeds to step 418. If not, then the system routes the user to step 418.

In step 418, the user has the option to prepare a report on the selected visualization(s), and then in step 420, the user may select a general option or return to the display of options in step 404. If the user selects a general option, for example in step 422 to save the visualization(s) in the appropriate database, in step 424 to output the visualization(s), for example by printing, or in step 426 to share the visualization(s), for example by saving them locally (e.g., as a jpg, pdf, or ppt file), emailing them, posting them to an intranet, etc. The user is then returned to step 420, where she may select another general option or to return to the display of options in step 404. In step 428, the user selects to create a new visualization, and then the system routes the user through point B to step 464 (as shown in FIG. 6B).

In FIG. 6B, in step 432 the selected visualization is displayed. The visualization may be any appropriate visualization, for example a lifecycle change diagram such as a bullseye diagram (depicted in FIGS. 7A through 7D), end-point diagram (depicted in FIGS. 8A and 8B), or racetrack diagram (depicted in FIGS. 9A and 9B), or an evaluation diagram such as a Gantt chart (depicted in FIG. 10) or retirement risk matrix (depicted in FIG. 11). The lifecycle change diagrams illustrate various plot points for each topic depending on its business scores, e.g., business impact, risk, uncertainty, alignment score, or lifecycle stage. This may be illustrated by, for example, each topic being displayed by an indicator such as a colored circle or triangle, with the diameter of the circle increasing depending on the business impact (value), and the color of the indicator depending on the degree of risk, e.g., green for low risk, yellow for medium risk, and red for high risk. In other diagrams, for example a Gantt chart, color may be used in a different fashion, such as to illustrate the phase of a particular topics, e.g., blue for an emerging phase, green for a core phase, yellow for a declining phase, and red for a retired phase.

In step 434, if the user enters a modification, then the system proceeds to step 436, but if not, proceeds to step 444. In step 436, the system determines if the modification is a global change, and if yes, routes the user through point B to step 464, but if not, proceeds to step 438. In step 438, the system determines if the modification is a data modification, such as adding an individual technology point, or a manual edit of an existing roadmap, or a non-data modification, such as filtering by, e.g., weighted wedge, aggregate results (per category, per year, etc.), selection of a particular tag, hiding labels, or a category selection. If the determination is yes (data modification), then the system proceeds to step 440, and if not (non-data modification) proceeds to step 442. In step 440, the system determines if the user is a superuser permitted to make data modifications, and if not proceeds to step 444. If yes, then the system proceeds to step 442, where the system displays the modified visualization. Depending on the selected modification, the modification may be the removal of various points that have been filtered out, or the display of an edited point or a topic label.

In step 444, depending on the particular visualization the user may have the option to select a comparison. If unavailable or the user does not select this option, the system proceeds to step 450. If available and the user selects this option, then in step 446 the system retrieves the appropriate comparison data from the appropriate database. The comparison data may be, e.g., global benchmark data, industry data (e.g., from banking or research industries), other companies in various revenue brackets, adoption stance (e.g., early adopters, fast followers, etc.), or saved maps. In step 448 the system displays the comparison data, for example by plotting points for the comparison data and connecting the entity and comparison points, or by illustrating comparison data next to the entity data such as is further described with reference to FIGS. 7C, 7D, 8B and 9B. The system then proceeds to step 450.

In step 450, if the user selects a data point, for example by clicking on it or hovering over it, the system in step 452 displays details of the data point, for example a description of the data point, a list or visualization of data dependencies related to the selected data point, the business score information for the topic, drill down information such as links to research information, bar charts showing industry adoption of this particular topic, etc. If not, or after step 452, the system then proceeds to step 454. In step 454, the user may decide to refresh the visualization display (step 456) by returning to step 432, or may select a general option. If the user selects a general option, for example in step 458 to save the visualization(s) in the appropriate database, in step 460 to output the visualization(s), for example by printing, or in step 462 to share the visualization(s), for example by saving them locally (e.g., as a jpg, pdf, or ppt file), emailing them, posting them to an intranet, etc. The user is then returned to step 454, where she may select another general option, refresh the visualization in step 456, or to exit the process in step 430.

At step 464, the system receives a visualization selection from the user, for example a lifecycle change diagram such as a bullseye diagram (depicted in FIGS. 7A through 7D), end-point diagram (depicted in FIGS. 8A and 8B), or racetrack diagram (depicted in FIGS. 9A and 9B), or an evaluation diagram such as a Gantt chart (depicted in FIG. 10) or retirement risk matrix (depicted in FIG. 11). In step 466 the system receives an entity selection from the user, for example the selection of an entire company, one or more business units with the company, or one or more locations. In step 468 the system receives the selection of a time period from the user, for example a range of years such as 2011-2015, or a particular year such as 2013. In step 470, the system retrieves the entity data from the appropriate database, and in step 472 the system may, depending on the selected visualization, receive the selection of a lifecycle stage from the user. Lifecycle stages may include, e.g., emerging, core, installed standard, installed non-standard, declining, or retired. After step 472, the system proceeds to step 432 to display the visualization.

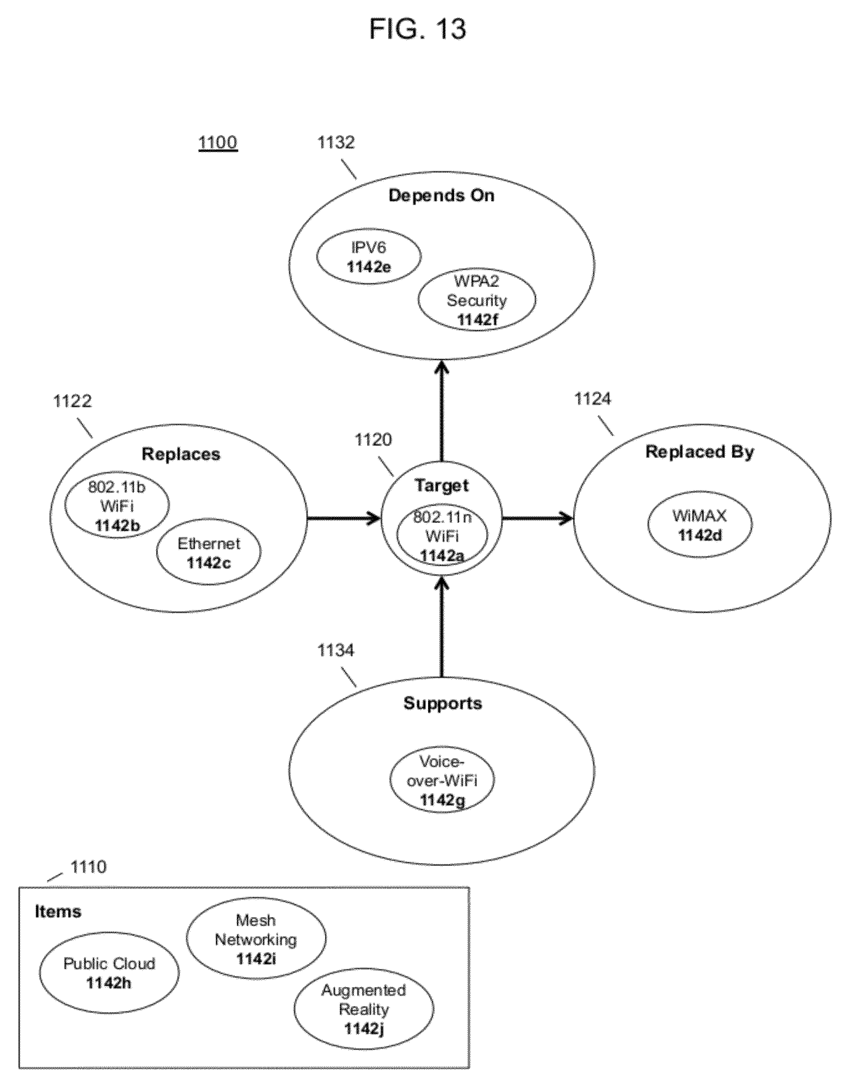

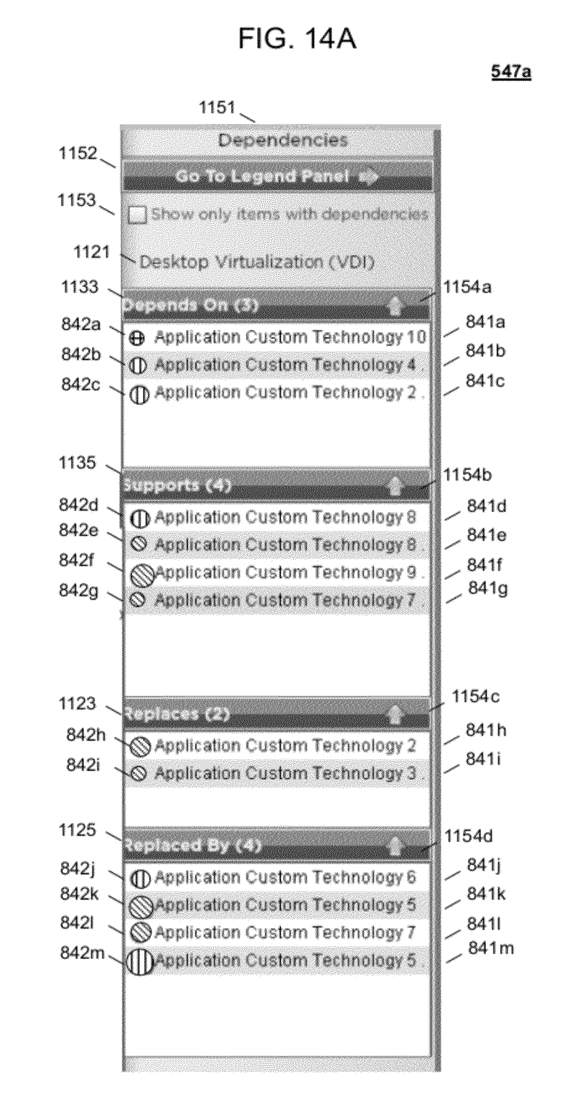

Referring now to FIG. 12, reference numeral 1000 generally designates a flowchart depicting an exemplary process of defining data dependencies 1000, where the user may define all of the data dependencies related to a particular item (e.g., a topic or sub-topic), according to an embodiment of the present invention, which may be carried out by the host device 20 previously described, and in particular by the roadmap server 25 in conjunction with other components. In the examples depicted in FIGS. 12 and 13, there are four types of data dependency (e.g., “depends on”, “supports”, etc.) but it is understood that fewer (or more) types may be used in any particular implementation of the present embodiments. For example, other types of data dependency may include, but are not limited to, for example “impacts”, “impacted by”, “contains”, “is a part of”, “starts after”, “completes before” and others as appropriate for use.

The process starts at step 1005, for example by a user of a client device 30 choosing to specify the details of a topic in step 250 of process 200. In step 1010, the user selects a target item, and then in step 1020 the user selects one or more items that “depend on” (e.g., require implementation of) the target item. In step 1030, the user selects one or more items that “support” the target item (e.g., the target item requires implementation of these items). In step 1040, the user selects one or more items that “replace” the target item (e.g., the target item will be phased out in favor of these items), and in step 1050 the user selects one or more items that are “replaced by” the target item (e.g., these items were phased out in favor of the target item). The items may be selected in any suitable manner, for example by selecting the item from a list of other items, by selecting them from drop-down menus, or by visualizing “dragging” the item into a specific zone of a graphical user interface (GUI), etc. An example of a GUI for defining data dependencies is provided in FIG. 13.

Referring now to FIG. 13, reference numeral 1100 generally designates a GUI 1100 for defining data dependencies in a visual manner. The GUI 1100 comprises an item list 1110 and a number of regions or zones 1120, 1122, 1124, 1132, 1134. The user is able to define the dependency data for a particular target item by dragging items 1142 from the item list 1110 into a region or zone 1120, 1122, 1124, 1132, 1134.

For example, in the example shown in FIG. 13, the user has selected item 1142a labeled “802.11n WiFi” as the target item by dragging it into the target region 1120. The user has also selected two items 1142b and 1142c as items that have been replaced by the target item, by dragging them to the “Replaces” region 1122, and has similarly selected one item 1142d as an item that will replace the target item by dragging it to the “Replaced By” region 1124. The user has also selected two items 1142e and 1142f as items on which the target item depends, by dragging them to the “Depends On” region 1132, and has selected one item 1142g as an item that supports the target item, by dragging it to the “Supports” region 1134. Three items 1142h, 1142i, 1142j remain uncategorized in the item list 1110.

C. Example Roadmap Visualizations

Referring now to FIGS. 7A through 7E, reference numerals 500 and 505 generally designate a lifecycle change diagram referred to as a bullseye diagram, according to an embodiment of the present invention. FIGS. 7A, 7C and 7E depict whole diagrams, and FIGS. 7B and 7D represent a segment of the bullseye diagram that has been enlarged for easier viewing. FIGS. 7A through 7E are lined for color with respect to the below-described visualization key 535, entity datapoints 540, and comparison datapoints 550, in which the color green is represented by diagonal lining; the color yellow is represented by cross-hatched lining; the color red is represented by solid vertical lining; the color blue is represented by solid horizontal lining; and the color gray is represented by dashed (broken) horizontal lining.

In the bullseye diagrams 500, 501, 502, 505, 506 the wedges 510a, 510b, 510c, 510d, 510e each represent a category having a respective label 511a, 511b, 511c, 511d, 511e, and the concentric rings 520a, 520b, 520c, 520d, 520e each represent a time period or other user-defined data attribute. For example, in FIGS. 7A through 7D, the concentric rings 520 each represent years (of which there may be any number depending on the time period selected for display) or other time periods (e.g., “no plans to deploy” representing a null time period) having a respective label on time indicator 530. In FIG. 7E, the concentric rings 520 each represent a user-defined security threat level having a respective label on risk indicator 531. Other user-defined data attributes suitable for use in the bullseye diagrams include, e.g., maturity levels, project phases, business impact level, etc. There may be any number of wedges 510 and rings 520 shown, depending on the number of categories and time periods (or other user-defined data attribute) selected for display. For example, FIG. 7A depicts five wedges 510 and five concentric rings 520, whereas FIG. 7E depicts three wedges 510 and four concentric rings 520.

Each of the bullseye diagrams 500, 501, 502, 505, 506 has plotted in each wedge one or more entity datapoints 540 with respective labels 541, each datapoint representing a topic falling within the category in which wedge it is plotted. The characteristics of the plotted datapoints 540 indicates their relative business scores, for example the size of the datapoints indicates their business impact, with more valuable (higher impact) topics being represented by larger datapoints, and the color of the datapoints indicates the relative risk of implementing the topic, with low risk shown in green, medium risk in yellow, and high risk in red. The bullseye diagram 500, 501, 502, 505, 506 may also comprise a visualization key 535, 536, such as the ones shown in FIG. 7A, 7C, 7D and 7E, to allow the user to easily understand what is meant by the sizes, shapes and colors of the datapoints 540 and any other plotted information.

The number of datapoints may be lesser or greater than those shown in the examples of FIGS. 7A through 7E, depending on the number of topics selected for display. It should also be understood that although only three colors are depicted in FIGS. 7A through 7E, more or fewer colors may be used, for example multiple colors along a spectrum from greens through yellow-greens, yellows, and oranges to red may be used to indicate finer gradations of risk. It should also be understood that size could be used to connote other business scores or factors such as cost of investment, and color could be used to connote other business scores or factors such as certainty of risk, as well.

The entity datapoints 540 may be placed by the user, arranged randomly in their assigned wedge 510 and ring 520, or plotted automatically via a graphing or drawing algorithm, for example a force-directed algorithm or an Eigen value drawing algorithm, that is easily implemented, has flexibility, and produces an aesthetically pleasing and/or symmetrical result. A force-directed algorithm is designed to plot nodes (e.g., the entity datapoints 540) based on optimization methods that rearrange the positions of the nodes to find a layout with minimum energy. An Eigen value drawing algorithm finds the optimal drawing layout by minimizing the quadratic energy function of the various nodes. For example, a force-based algorithm may be used to automatically plot the entity datapoints 540 within their respective wedges 510 and rings 520 based on repulsive forces assigned to the entity datapoints 540, their labels 541, the edges (inner and outer) of the rings 520, and the edges of the wedge 510.

Turning now to FIG. 7B, which depicts an enlarged wedge 510e of the bullseye diagram 500 of FIG. 7A, wedge 510e represents the category “network” (label 511e), and has five datapoints 540 plotted therein. For example, entity datapoint 540a in ring 520a (year 2009) represents topic “802.11n WiFi” and is shown in green (diagonal lining), datapoint 540c in ring 520d (year 2012+) represents topic “Mesh Networking” and is shown in yellow (cross-hatched lining), and datapoint 540e in ring 520e (no plans to deploy) represents topic “4G Mobile Data” and is shown in red (vertical lining).

FIG. 7B also shows that in addition to the data (e.g., business scores) communicated by the size, shape and color of the datapoints 540, other information can be provided about any particular datapoint. For example, if the user selects a data point, e.g., by clicking on it or hovering over it, the system displays details of the data point, for example in a pop-up window 545 or float-over window 547, that provides further information about the selected datapoint, for example drill down information such as links to research information, bar charts showing industry adoption of this particular topic, complete business score information, etc. Shown here in FIG. 7B is a pop-up box 545b, which shows exemplary information regarding the risk score and valuation score for datapoint 540b. The float-over window 547 may depict data dependency information, for example as shown in FIGS. 14A and 14B. Uncertainty scores may also be depicted, for example by indicating the margin of uncertainty by showing a halo 546d around the entity datapoint 540d, by changing the color of the datapoint, etc.

The bullseye diagram 500, 505 may represent a portion or all of a particular entity's data, for example the bullseye diagrams of FIGS. 7A and 7B, or it may represent a comparison between a particular entity's data and comparison data, for example the comparison bullseye diagrams 501, 506 of FIGS. 7C and 7D. The comparison bullseye diagrams depict the result of a comparison, for example when the user has chosen to compare her entity's bullseye data with benchmarking data from, e.g., another industry and/or revenue bracket. As is best seen in FIG. 7D, in the comparison bullseye 506, additional comparison datapoints 550 are plotted in each wedge, and shown connected to their corresponding entity datapoints 540 with lines or other connectors.

The comparison data may be understood as follows. Referring now to FIG. 7D, entity datapoint 540a in ring 520b has a comparison datapoint 550a that is drawn on top of datapoint 540a because implementation of this topic by the benchmarking industry is expected to occur (or has occurred) in the same year as the entity's implementation. If topic implementation dates differ between the entity and the benchmarking industry, then the comparison datapoint 550 is drawn in a different ring 520 and is connected to the entity datapoint 540 by a line, wedge, or other connector 548. For example, entity datapoint 540b in ring 520d is connected to its comparison datapoint 550b in ring 520a by a wedge 548b, and entity datapoint 540c in ring 520e is connected to its comparison datapoint 550c in ring 520c by a line 548c. The use of a wedge instead of a line may indicate, for example, that the comparison datapoint is located outside the currently depicted year range, for example at a year earlier than is shown or in no year at all.

The relative sizes and colors of the entity datapoints 540 and the comparison datapoints 550 may also provide comparative information, for example that the business impact (value) of this topic is valued differently by the entity than by the benchmarking industry, and that the risk of this topic is expected to be different by the entity than by the benchmarking industry. For example, entity datapoint 540a has a medium size to indicate a medium business impact (value) and is colored green (diagonal lining) to indicate a low risk of implementation. Comparison datapoint 550a also has a medium size, and may be colored gray (broken horizontal lining) as a neutral color, or it may be colored on the same color scale as the datapoints 540 to indicate, e.g., that the risk of this topic is expected to be different (e.g., higher or lower) by the benchmarking industry as compared to the entity. Entity datapoint 540c and its comparison datapoint 550c are both of medium size, however entity datapoint 540c is colored yellow (cross-hatched lining) to indicate medium risk of implementation, and comparison datapoint 550c is colored red (solid vertical lining) to indicate that the risk of implementing this topic is expected to be higher by the benchmarking industry as compared to the entity.

The comparison data may also indicate if a topic is implemented by only the entity and not the benchmarking industry, or if a topic is implemented by the benchmarking industry and not the entity. For example, entity datapoint 540d in ring 520b has no matching comparison datapoint, which indicates that the benchmarking industry is not implementing this topic (or that data is incomplete for this topic). Similarly, comparison datapoint 550e in ring 520c has no matching entity datapoint, which indicates that the benchmarking industry is implementing this topic, but the entity is not.

It is understood that variations of these diagrams may also be utilized. For example, while the bullseyes of FIGS. 7A through 7E depict a variety of technology topics grouped into generalized categories such as networking technologies, collaborative technologies, etc., the topics may be, e.g., various forms of risk to an entity, grouped into generalized categories such as market risks, geopolitical risks, regulatory risks, supplier risk, etc. In such a scenario, the concentric rings 520 may represent levels of threat (e.g., primary threats, secondary threats, and tertiary threats) instead of years, the size of the datapoint 540 may represent the immediacy or urgency of the threat instead of the business impact, and/or the color of the datapoint 540 may represent the entity's current level of preparedness or ability to respond to a particular threat. Or, the same data that can be organized by year, for example as shown in FIG. 7A, can also be organized by business impact or risk level, for example as shown in FIG. 7E.

The wedges 510 and rings 520 may also vary in size, and need not be uniform. For example, FIG. 7A depicts five wedges 510 of equal dimensions, while FIG. 7E depicts three wedges 510 of unequal size. FIG. 7A also depicts five rings 520 of approximately equal thicknesses, while FIG. 7C depicts four rings 520 of unequal thicknesses. The wedge and ring sizes may be determined by the user for aesthetic reasons, or may be determined by an algorithm based on the data plotted therein, for example if a category contains more datapoints than the other depicted categories, the larger category may be assigned to a proportionally larger wedge. Similarly, if a ring contains more datapoints than other depicted rings, the thickness of the ring may be increased so that its datapoints have approximately the same spatial distribution as those of the other rings.

Referring now to FIGS. 8A and 8B, reference numerals 600 and 605 generally designate a lifecycle change diagram referred to as an end-point diagram, according to an embodiment of the present invention. FIGS. 8A and 8B are lined for color with respect to the below-described entity datapoints 640, and comparison datapoints 650, in which the color green is represented by diagonal lining; the color yellow is represented by cross-hatched lining; the color red is represented by solid vertical lining; and the color gray is represented by dashed (broken) horizontal lining.

In the endpoint diagrams 600, 605, the segments 610a, 610b, 610c, 610d, 610e, 610f each represent a category having a respective label 611a, 611b, 611c, 611d, 611e, 611f and the concentric rectangles 620a, 620b, 620c, 620d each represent years (of which there may be any number depending on the time period selected for display) or other time periods (e.g., “no plans to deploy” representing a null time period) having a respective label on time indicator 630 or otherwise. Label 615 indicates a tag expressing a goal or a priority for the entity. Each rectangle 620 representing each year may be broken into sub-rectangles, for example one per month, one per quarter, one per six months, or the like, for example in FIG. 8A the rectangles 620a, 620b, 620c are broken into sub-rectangles for each quarter of each of years 2010-2012. Although six segments 610 and thirteen concentric rectangles 620 are shown here, it is understood that the number of segments and concentric rectangles may be lesser or greater depending on the number of categories and time periods selected for display.

Plotted in each segment are entity datapoints 640 with respective labels 641, each entity datapoint representing a topic falling within the category in which segment it is plotted. For example, as shown in FIG. 8A, three entity datapoints 640 within rectangle 620b representing year 2011 are plotted. Datapoint 640a in segment 610a represents topic “80% server visualized” within category “Service”, datapoint 640b in segment 610b represents topic “Backup Remediation” within category “Storage”, and datapoint 640c in segment 610d represents topic “Non-Windows Support” within category “End User Computing.” The size of the datapoints 640 indicates their business impact, with more valuable (higher impact) topics being represented by larger datapoints, and the color of the datapoints indicates the relative risk of implementing the topic, with low risk shown in green (diagonal lining), medium risk in yellow (cross-hatched lining), and high risk in red (vertical lining). It should also be understood that although only three colors are depicted, more or fewer colors may be used, for example multiple colors along a spectrum from greens through yellow-greens, yellows, and oranges to red may be used to indicate finer gradations of risk.

This type of diagram may also be used to illustrate comparative data, for example as shown in FIG. 8B. In a comparison diagram, additional comparison datapoints 650 are plotted in each segment, and shown connected to their corresponding entity datapoints 640 with lines or other connectors. If no comparison data is available for a particular entity datapoint 640, then that entity datapoint may be omitted from the comparison diagram 605, for example datapoint 640d from endpoint diagram 600 in FIG. 8A is not depicted in the comparison diagram 605 in FIG. 8B. Exemplary comparison datapoint 640b is located in the first quarter of 2011, but comparison datapoint 650b is located in the third quarter of 2011, and also has a smaller size than entity datapoint 640b. The location of comparison datapoint 650b in a different year than entity datapoint 640b indicates that implementation of this technology topic by the benchmarking industry is expected to occur (or has occurred) in a different time period. Datapoint 640c similarly indicates that the entity is implementing a particular technology topic later than the benchmarking industry. The relatively smaller size of the comparison datapoint 650b relative to entity datapoint 640b indicates that business impact (value) is considered to be less by the benchmarking industry than by the entity. In this case, the color of both datapoints is the same, indicating that the risk is evaluated similarly by the entity and by the benchmarking industry.

Referring now to FIGS. 9A and 9B, reference numerals 700 and 705 generally designate a lifecycle change diagram referred to as a racetrack diagram, according to an embodiment of the present invention. FIGS. 9A and 9B are lined for color with respect to the below-described entity progress arrows 740, and comparison arrows 750, in which the color green is represented by diagonal lining; the color yellow is represented by cross-hatched lining; the color red is represented by solid vertical lining; and the color gray is represented by dashed (broken) horizontal lining.

In the racetrack diagrams 700, 705, the horizontal regions 710a, 710b, 710c each represent a category having a respective label 711a, 711b, 711c, and comprise one or more rows representing topics within that category and having respective labels 741a, 741b, 741c, etc. The “columns” or phases 720 in the diagram each represent a particular phase, for example the emerging phase 720a, installed non-standard 720b, installed standard 720c, declining 720d, and retired 720e phases depicted here. Time indicator 730 indicates the particular time period shown, in this case the second quarter of 2011, but which may be a month, quarter, half-year, year, group of years, or any other desired time period. Although three categories 710 each having three topics are shown here, it is understood that the number of categories and topics may be lesser or greater depending on the number selected for display.

Plotted on racetrack diagrams 700, 705 are entity progress arrows 740 for each topic, with the length of the arrows indicating the current phase (at the selected time period) of the topic, the size of the arrowhead indicating the business impact (value) of the topic, and the color of the arrow and arrowhead indicating the implementation risk of the topic. For example, as shown in FIG. 9A, the “Application Virtualization” topic 741a is represented by a green arrow 740a, which extends to phase 720c to show that this topic is currently in the “installed standard” phase, the “Windows 7” topic 741b is represented by a yellow arrow 740b, which extends to phase 720a to show that this topic is currently in the “emerging” phase, and the “RFID systems” topic 741c is represented by a green arrow 740c, which extends to phase 720d to show that this topic is currently in the “declining” phase. The size of the arrowheads 740 indicates their business impact, with more valuable (higher impact) topics being represented by larger arrowheads, and the color of the arrows indicates the relative risk of implementing the topic, with low risk shown in green (diagonal lining), medium risk in yellow (cross-hatched lining), and high risk in red (vertical lining). It should also be understood that although only three colors are depicted, more or fewer colors may be used, for example multiple colors along a spectrum from greens through yellow-greens, yellows, and oranges to red may be used to indicate finer gradations of risk.

This type of diagram may also be used to illustrate comparative data, for example as shown in FIG. 9B. In a comparison diagram, additional comparison arrows 750 are plotted in gray (broken horizontal lining) for each topic next to the entity arrows 740. For example, for topic 741a, comparison arrow 750a is plotted next to entity arrow 740a, however comparison arrow 750a extends to a different phase, installed standard 720b. This difference indicates that the benchmarking industry is in a different stage of the lifecycle for this technology than is the entity. Similarly, 740c and 750c indicate that the benchmarking industry is in an earlier stage of the lifecycle for this technology than the entity. The entity and comparison arrows 740a, 750a have the same size arrowhead, indicating that the business impact is the same for the entity as for the benchmarking industry.

Referring now to FIG. 10, reference numeral 800 generally designates an evaluation diagram referred to as a Gantt chart diagram, according to an embodiment of the present invention. FIG. 10 is lined for color with respect to the below-described visualization key 535, phase selectors 835, 836, 837, 838 and 839, data bars 840, and indicator symbols 842, in which the color green is represented by diagonal lining; the color yellow is represented by cross-hatched lining; the color red is represented by solid vertical lining; the color purple is represented by dashed (broken) vertical lining; the color blue is represented by solid horizontal lining; and the color gray is represented by dashed (broken) horizontal lining.

In the Gantt chart 800, the horizontal regions 810a, 810b each represent a category having a respective label 811a, 811b, and comprise one or more rows representing topics within that category and having respective labels 841a, 841b, etc. The “columns” 820 in the diagram each represent a particular time period, such as a month, quarter, or year. Time indicator 830 indicates the overall time period shown, in this case the years 2012 through 2015. Although two categories 810 and four years are shown here, it is understood that the number of categories, topics, and years may be lesser or greater depending on the number selected for display. For example, time selector 831 allows the user to select a number of years for display.

The Gantt chart 800 also may include a visualization selector 832, for example that comprises a pull-down menu allowing the user to select a particular visualization for display. The Gantt chart 800 may further include a dependency selector 833 for showing or hiding data dependencies, that may be selected by the user in order to bring up dependency information, for example as a sidebar or as the depicted float-over window 547. The float-over window 547 may depict data dependency information, for example as shown in FIGS. 14A and 14B. The Gantt chart 800 may also include other selectors, for example the depicted phase selectors 835, 836, 837, 838 and 839, which may be individually selected to show or hide data corresponding to that phase, as is further explained below. The Gantt chart 800 may also include a visualization key 535, such as the key depicted in FIG. 10 that indicates what the color of each indicator 842 and data bar 840 represents.

Each topic plotted on the Gantt chart 800 has a corresponding data bar 840, topic label 841, and indicator symbol 842. The data bars 840 each comprise one or more segments 845, 846, 847, 848, 849 representing a phase of the topic at a particular time period. A data bar 840 may contain no segments, as shown for the topic having the label 841g “Exchange 2010”, or may contain one or more segments. For example, the topic having the label 841c “Flywheel UPS” is represented by data bar 840c, which has three segments 845c, 846c, 847c. The first segment 845c is colored red (solid vertical lining) to indicate that in this segment (corresponding to the year 2012) the topic is in an emerging phase, the second segment 846c is colored yellow (cross-hatched lining) to indicate that in this segment (corresponding to the year 2013) the topic is in an installed non-standard phase, and the third segment 847c is colored green (diagonal lining) to indicate that in this segment (corresponding to the years 2014 and 2015) the topic is in an installed standard phase. Similarly, the topic having the label 841f “Rack-Mounted/Based Liquid Cooling” is represented by data bar 840f, which has two segments 848f, 849f. The first segment 848f is colored blue (solid horizontal lining) to indicate that in this segment (corresponding to the year 2012) the topic is in a declining phase, and the second segment 849f is colored gray (broken horizontal lining) to indicate that in this segment (corresponding to the years 2013-2015) the topic is in a retired phase.

The data bars 840 may vary from those depicted in a number of ways. For example, other colors may be used to depict the various phases, for example white segments 844 (shown in FIG. 14B) may be used to indicate a pre-installation phase, or all of the phases may be colored according to a different scheme, for example installed topics may be colored green, declining topics may be colored yellow, and retired topics may be colored red. Or, for example, if a different time period is shown, some of the segments may be hidden from view, for example data bar 840c does not show when this topic will be in a declining or retired phase. Or, for example it may be desirable to show only certain phases, which can be accomplished by the user selecting or de-selecting the appropriate phase selectors 835, 836, 837, 838 and 839 to change the display. It is also understood that the data bars 840 may be plotted across any suitable time increment, for example weeks, months, quarters, or years, and that any given segment may start or begin in any such time increment.

Gantt chart 800 also includes an indicator symbol 842 for each displayed topic. The indicator symbol may have any suitable shape, for example a circle, square, triangle, star, etc., and its size and color generally represent the business impact (value) and risk of this particular topic, as described above with respect to the datapoints 540. For example, the topic having the label 841c “Flywheel UPS” has a small yellow indicator 842c representing that this topic has a small impact and medium risk of implementation, the topic having the label 841f “Rack-Mounted/Based Liquid Cooling” has a large green indicator 842f representing that this topic has a large impact and low risk of implementation, and the topic having the label 841g “Exchange 2010” has a small blue indicator 842g representing that this topic is not implemented by the entity.

Referring now to FIG. 11, reference numeral 900 generally designates an evaluation diagram referred to as a retirement risk matrix, according to an embodiment of the present invention. The retirement risk matrix provides a single visualization illustrating alignment (or the lack thereof) between an entity's current state for one or more topics and a desired state, either of the entity or in a benchmarking industry. In the retirement risk matrix, the x-axis 902 represents risk (labeled here as IT risk, e.g., a risk that a problem will occur with a particular topic), and the y-axis 904 represents business impact (e.g., the magnitude of business impact faced if a problem occurred with a topic). The user may provide a selection of one or more categories to limit the number of topics illustrated in the matrix 900.

Each topic is represented by a datapoint 940, which is positioned along the x-axis and y-axis according to its risk and business impact scores. FIG. 11 is lined for color with respect to the datapoints 940, wherein the color green is represented by diagonal lining; the color yellow is represented by cross-hatched lining; and the color red is represented by solid vertical lining. The color of each datapoint 940 indicates its alignment score, which is a measurement of the alignment between the actual phase of a particular topic and the desired phase. For example datapoint 940a represents the “Social Networking” topic, and the green color (diagonal lining) indicates that this topic is in good alignment with its desired phase (high alignment score). Datapoint 940d represents the “SQL server 2003” topic, and its red color (solid vertical lining) indicates that this topic is in major misalignment with its desired phase (low alignment score), for example because the topic should be retired but is still in major use within the entity. Similarly, datapoint 940f represents the “Microsoft Office 2003” topic, and its yellow color (cross-hatched lining) indicates that this topic is in moderate misalignment with its desired phase (medium alignment score), for example because the topic should be retired but is still used to some degree within the entity. Time indicator 930 indicates the overall time period shown, in this case the first quarter of the year 2011.

Referring now to FIGS. 14A and 14B, two different example float-over windows 547 are depicted, each showing dependency information. Each of these float-over windows 547 may be overlaid on any of the previously described visualizations depicted in FIGS. 7 through 11, for example over a bullseye diagram or a Gantt chart. Although the depicted information is dependency information, it is understood that a float-over window may provide any desired information about a particular topic, for example detailed data such as the risk and impact scores used to size and color a datapoint, a description of the topic, tags assigned to the topic, links to research information, etc. The float-over window may also display, e.g., an alert to draw user attention for a number of reasons, for example if more information is needed about a particular topic, if a topic has one or more business values meeting or exceeding a predetermined threshold, if a topic has conflicting dependencies, etc.

In FIG. 14A, the float-over window 547a comprises a title bar 1151, a control bar 1152, a selection box 1153, and a label 1121 indicating the topic for which information is being shown. For example, for the depicted window 547a, information is shown for the topic having the label 1121 “Desktop Virtualization (VDI)”. The window 547a also comprises four label bars 1154 that each correspond to a particular type of dependency information. For example, label bar 1154a corresponds to the “Depends On” type 1133 of dependency information, and this region of the window 547a comprises three topics having labels 841 and indicator symbols 842. Similarly, label bar 1154b corresponds to the “Supports” type 1135 of dependency information, label bar 1154c corresponds to the “Replaces” type 1123 of dependency information, and label bar 1154d corresponds to the “Replaced By” type 1125 of dependency information.

As described above with respect to datapoints 540, the indicator symbols 842 may have any suitable shape, size and color to represent the business scores, e.g., the business impact (value) and risk of this particular topic. FIG. 14A is lined for color with respect to the indicator symbols 842, wherein the color green is represented by diagonal lining; the color yellow is represented by cross-hatched lining; and the color red is represented by solid vertical lining.

In FIG. 14B, the float-over window 547b comprises a title bar 1151 indicating the topic for which information is being shown, a dependency type label 1130 showing the type of dependency information being shown in the window (in this case “Supports” type), a topic description 1155, and topic information including a topic data bar 840, topic label 841, and one or more date indicators 1161. FIG. 14B is lined for color with respect to the data bars 840, wherein the color green is represented by diagonal lining; the color yellow is represented by cross-hatched lining; the color red is represented by solid vertical lining; the color purple is represented by dashed (broken) vertical lining; the color blue is represented by solid horizontal lining; and the color gray is represented by dashed (broken) horizontal lining.

As described above with reference to the Gantt chart 800 of FIG. 10, each data bar 840 comprises one or more segments 844, 845, 846, 847, 848, 849 representing a phase of the topic at a particular time period. The phases may be depicted by colors, patterns, or other indicators. For example, for the topic having label 841a and data bar 840a, the segment 845a representing the emerging phase is colored red (solid vertical lining) and is prefaced with a date indicator 1161 indicating that the emerging phase began in Quarter 1 of 2010, and the segment 847a representing the installed standard phase is colored green (diagonal lining) and is prefaced with a date indicator 1161 indicating that this phase will begin in Quarter 2 of 2013. Similarly, for the topic having label 841b and data bar 840b, the segment 848b representing the declining phase is colored blue (solid horizontal lining), and is prefaced with a date indicator 1161 indicating that the declining phase began in Quarter 1 of 2011.

D. Example Details of Implementation

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The computer systems of the present invention embodiments may be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.).

It is to be understood that the software for the computer systems of the present invention embodiments may be implemented in any desired computer language and could be developed by one of ordinary skill in the computer arts based on the functional descriptions contained in the specification and flow charts illustrated in the drawings. By way of example only, the software may be implemented in the C, C++, Java, P1/1, Fortran or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Further, any references herein of software performing various functions generally refer to computer systems or processors performing those functions under software control.

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram.

Any combination of one or more computer readable medium(s) may be utilized. The computer readable medium may be a computer readable signal medium or a computer readable storage medium, such as a computer readable storage device. A computer readable medium may be, for example, but is not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a solid state disk, a random access memory (RAM), a read-only memory (ROM), an erasable programmable read-only memory (EPROM or Flash memory), an optical fiber, a portable compact disc read-only memory, an optical storage device, a magnetic storage device, a phase change memory storage device, or any suitable combination of the foregoing. For example, a computer readable storage medium may be any tangible medium that can contain or store a program for use by or in connection with an instruction execution system, apparatus, or device.

The flowchart and block diagrams in the Figures illustrate the architecture, functionality, and operation of possible implementations of systems, method and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometime be executed in the reverse order, depending on the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

This application is being filed with informal drawings containing items shaded in gray-scale (e.g., ring 520c of FIG. 7B) as well as elements lined for color (e.g., datapoint 540a of FIG. 7B). Unless an element is either lined for color in the informal drawings, or is described in the specification as being depicted in a particular color or colors, such shading in gray-scale is not intended to be a part of the presently-described embodiments, and Applicants reserve all rights to remove such shading upon the submission of formal drawings.

What is claimed is:

1. A computer-implemented method for generating a roadmap visualization for a set of topics, comprising:
a computer receiving topic data about each topic in a set of topics from an entity;
analyzing, by the computer, the received topic data to calculate one or more business scores for each topic;
generating a visualization by the computer plotting entity datapoints for each topic in a visualization format, where visual characteristics of the entity datapoints indicate the business scores for each topic; and
displaying the visualization on a display device communicatively connected to the computer.

2. The computer-implemented method of claim 1, further comprising:
the computer receiving a user selection of comparison topics, wherein each comparison topic corresponds to a topic in the set of topics from the entity;
analyzing, by the computer, comparison data about the comparison topics to calculate one or more comparative business scores for each comparison topic;
generating a comparison visualization by the computer plotting comparison datapoints for each comparison topic in the visualization format, where visual characteristics of the comparison datapoints indicate the comparative business scores for each comparison topic; and
displaying the comparison visualization on the display device.

3. The computer-implemented method of claim 2, further comprising:
the computer plotting a linkage indication between each comparison datapoint and its corresponding entity datapoint prior to said display of the comparison visualization.

4. The computer-implemented method of claim 1, wherein each of said one or more business scores is selected from the group consisting of a risk score, a business impact score, an implementation score, an uncertainty score and an alignment score.

5. The computer-implemented method of claim 1, wherein the visualization format is a bullseye diagram comprising a set of concentric circles, wherein each circle in the set represents a user-defined data attribute selected from the group consisting of a time period, a security threat level, a maturity level, a project phase, and a business impact level.

6. The computer-implemented method of claim 1, wherein said plotting comprises the computer applying a force-directed algorithm to the entity datapoints.

7. The computer-implemented method of claim 1, wherein the topic data comprises data dependency information about the topic, and further comprising:
the computer receiving a user selection of a particular entity datapoint plotted in the visualization format;
in response to said receiving a user selection, displaying the data dependency information for the particular entity datapoint on the display device.

8. An apparatus comprising:
a memory having topic data about each topic in a set of topics stored therein; and
a processor configured to:
analyze the stored topic data to calculate one or more business scores for each topic;
generate a visualization by plotting entity datapoints for each topic in a visualization format, where visual characteristics of the entity datapoints indicate the business scores for each topic; and
communicate the visualization to a display device for display to a user.

9. The apparatus of claim 8, wherein the processor is further configured to:
receive a user selection of comparison topics, wherein each comparison topic corresponds to a topic in the set of topics from the entity;
analyze comparison data about the comparison topics to calculate one or more comparative business scores for each comparison topic;
generate a comparison visualization by plotting comparison datapoints for each comparison topic in the visualization format, where visual characteristics of the comparison datapoints indicate the comparative business scores for each comparison topic; and
communicate the comparison visualization to the display device for display to a user.

10. The apparatus of claim 9, wherein said generating the comparison visualization further comprises the processor plotting a linkage indication between each comparison datapoint and its corresponding entity datapoint.

11. The apparatus of claim 8, wherein each of said one or more business scores is selected from the group consisting of a risk score, a business impact score, an implementation score, an uncertainty score and an alignment score.

12. The apparatus of claim 8, wherein the visualization format is a bullseye diagram comprising a set of concentric circles, wherein each circle in the set represents a user-defined data attribute selected from the group consisting of a time period, a security threat level, a maturity level, a project phase, and a business impact level.

13. The apparatus of claim 8, wherein said plotting comprises the processor applying a force-directed algorithm to the entity datapoints.

14. The apparatus of claim 8, wherein the topic data comprises data dependency information about the topic, and wherein the processor is further configured to:
receive a user selection of a particular entity datapoint plotted in the visualization format;
in response to said receiving a user selection, communicate to the display device a dependency display comprising the data dependency information for the particular entity datapoint.

15. One or more computer readable media encoded with instructions that, when executed by a processor, cause the processor to:
receive into memory topic data about each topic in a set of topics from an entity;
analyze the received topic data to calculate one or more business scores for each topic;
store the calculated business scores for each topic in memory;
generate a visualization by plotting entity datapoints for each topic in a visualization format, where visual characteristics of the entity datapoints indicate the stored business scores for each topic; and
communicate the visualization to a display device for display to a user.

16. The computer readable media of claim 15, further comprising instructions that when executed cause the processor to:
receive a user selection of comparison topics, wherein each comparison topic corresponds to a topic in the set of topics from the entity;
analyze comparison data about the comparison topics to calculate one or more comparative business scores for each comparison topic;
generate a comparison visualization by plotting comparison datapoints for each comparison topic in the visualization format, where visual characteristics of the comparison datapoints indicate the comparative business scores for each comparison topic; and
communicate the comparison visualization to the display device for display to a user.

17. The computer readable media of claim 15, wherein each of said one or more business scores is selected from the group consisting of a risk score, a business impact score, an implementation score, an uncertainty score and an alignment score.

18. The computer readable media of claim 15, wherein the visualization format is a bullseye diagram comprising a set of concentric circles, wherein each circle in the set represents a user-defined data attribute selected from the group consisting of a time period, a security threat level, a maturity level, a project phase, and a business impact level.

19. The computer readable media of claim 15, wherein said plotting further comprises instructions that when executed cause the processor to:
applying a force-directed algorithm to the entity datapoints.

20. The computer readable media of claim 15, wherein the topic data comprises data dependency information about the topic, and further comprising instructions that when executed cause the processor to:
receive a user selection of a particular entity datapoint plotted in the visualization format;
in response to said receiving a user selection, communicate to the display device a dependency display comprising the data dependency information for the particular entity datapoint.
